(19) United States
(12) Patent Application Publication
(10) Pub. No.: US 2018/0190151 A1
(43) Pub. Date: Jul. 5, 2018

(54) DISPLAY MODULE FOR VISUALLY IMPAIRED PERSONS, DISPLAY SYSTEM FOR VISUALLY IMPAIRED PERSONS, AND CONTROL METHOD THEREFOR

(71) Applicant: Insik SEO, Daejeon (KR)

(72) Inventor: Insik SEO, Daejeon (KR)

(21) Appl. No.: 15/741,122

(22) PCT Filed: Feb. 21, 2017
(86) PCT No.: PCT/KR2017/001865

§ 371 Date: Dec. 29, 2017

(30) Foreign Application Priority Data
May 2, 2016 (KR) 10-2016-0053887
May 2, 2016 (KR) 10-2016-0053890

(51) Int. Cl. G09B 21/00; H01H 13/28; H01H 13/14

(52) U.S. Cl. CPC G09B 21/003; H01H 13/14; H01H 13/28

(57) ABSTRACT

The present invention relates to a display module for visually impaired persons, a display system for visually impaired persons, and a control method therefor, and more specifically, provides a display module for visually impaired persons, a display system for visually impaired persons, and a control method therefor, the display module for visually impaired persons providing information such as Braille, figures and images by using a plurality of protrusions which moves up and down so that a visually impaired person may obtain information through hand sensation.

### TECHNICAL FIELD

The present invention relates to a display module for visually impaired persons, a display system for visually impaired persons, and a control method therefor. More particularly, the present invention relates to a display module for visually impaired persons which displays information such as Braille words, figures, images by vertically moving a plurality of protrusions so that a visually impaired person may obtain information by sensing with his or her hand.

### BACKGROUND

Braille is a character symbol system that gives meaning to various dot patterns so that people can read and write through tactile sensing. In general, 3*2, 4*2, etc, of dot patterns are widely used for Braille characters, and the character system is variably formed by differing a number of dots and an array form.

Meanwhile, due to the development of the information and telecommunication industry, various IT devices such as computers, mobile phones, PDAs (personal digital assistants), PMPs (portable multimedia player), etc. are widely used. These IT devices are not easily used by people with physical disabilities, such as visually impaired persons, and visually impaired persons feel isolated from the usage of the IT devices, thus there is demand to resolve economic and social imbalance caused by digital divide.

Various software and Braille display devices have been developed so that the utilization rate of information of visually impaired persons is increased by using IT devices and the information gap is being reduced. Braille display devices are tactile devices that provide information to users through skin stimulation such as pressure, vibration, stimulation, etc. by being implemented in a cell with a plurality of pins.

For conventional Braille display devices, various methods are used according to an actuator type. A solenoid based method, a piezoelectric based method, a dielectric elastomer based method are typical methods thereof.

In a solenoid based method, magnetic force is generated according to an electrical signal input to a coil, a plunger disposed inside the coil that generates the magnetic force is moved by receiving the force so that Braille information is output.

In a piezoelectric based method, a piezoelectric element changes in a length thereof according to an electrical signal applied thereto, Braille information is directly recognized by the piezoelectric element having changed in the length thereof.

In addition, a dielectric elastomer based method is a method of compressing a dielectric elastomer in a thickness direction and expanding the dielectric elastomer in a direction along a surface by using mutual attractive forces by forming electrodes on both sides of the elastomer having a high dielectric constant such as silicone or urethane.

However, when using the solenoid as a Braille output element, it is difficult to integrate the solenoid in a small size, and when using the piezoelectric based method, a voltage difference between voltages applied to both ends of the piezoelectric to generate a change in a length thereof is considerably large so that control thereof is difficult. In addition, in the dielectric elastomer based method, in order to generate a volume change of the elastomer in a predetermined desired amount, a high voltage about 1-2 kV has to be applied thereto. In other words, it is difficult to provide a Braille display device that includes a driving part or a controller for the same or both for outputting Braille information, and the display device being a compact size, and providing excellent response factor.

Korean Patent No. 10-0734731 discloses a “Braille outputting module and a display apparatus with the same”.

The Braille outputting module is configured with a guide and a piezoelectric actuator. A shaft of the piezoelectric actuator is output to display Braille information by passing through a column hole of the housing.

[Documents of Related Art]

[Patent Document]

Korean Patent No. 10-0734731 (Registration date: Jun. 27, 2007)

### DISCLOSURE

### Technical Problem

Accordingly, the present invention has been made keeping in mind the above problems occurring in the prior art, and an object of the present invention is to provide a display module for visually impaired persons, a display system for visually impaired persons, and a control method therefor which have simple configuration, and are easy to control by minimizing a number of units to be controlled when displaying information by using protrusions.

The technical objects that can be achieved through the present invention are not limited to what has been particularly described hereinabove and other technical objects not described herein will be more clearly understood by persons skilled in the art from the following detailed description.

### Technical Solution

In order to accomplish the above object, the present invention provides a display module for visually impaired persons, the display module including: a display unit 100 in which a plurality of through holes 101 is formed in a predetermined array; an upper block 200 provided below each through hole 101 and vertically moving whereby an upper protrusion 210 thereof upwardly protrudes above the through hole 101 when the upper block 200 upwardly moves; an upper support block 300 fixing the upper block 200; a lower block 400 provided below each upper block 200, vertically moving, and upwardly pushing the upper block 200 when the lower block 400 upwardly moves; an elastic unit 500 provided below each lower block 400 and providing force to upwardly push the lower block 400; and a lower adjustment unit 600 adjusting the lower block 400 not to rise up to a predetermined height, wherein the upper support block 300 fixes the upper blocks in a row or column unit, and the lower adjustment unit 600 controls the lower blocks 400 not to protruded up to the predetermined height in a column or a row unit.

According to an embodiment of the present invention, there is provided a controlling method for a display system for visually impaired persons according to an embodiment of the present invention, wherein the system includes a display unit 100 in which a plurality of through holes 101 is formed in a predetermined array, a column driving unit 850 protruding upper protrusions 210 in a column unit above the display unit 100 according to a control command of a controller 900, and a row driving unit 800 fixing the upper protrusions 210 in a row unit according to a control command of the controller 900, the method including: step S10 of releasing, by the row driving unit 800, fixed states of the upper protrusions 210 of a row to be displayed; step S20 of protruding, by the column driving unit 850, the upper protrusion 210 of a column to be displayed of the row in which the fixed states of the upper protrusions 210 are released in step S10; step S30 of fixing, by the row driving unit 800, the upper protrusions 210 of the row in which the fixed states of the upper protrusions 210 are released in step S10; and step S40 of returning, by the column driving unit 850, to an initial state thereof which has been driven in step S20, wherein steps S10 to S40 are sequentially repeatedly performed in accordance with an order of predetermined rows.

According to an embodiment of the present invention, there is provided a display system for visually impaired persons according to an embodiment of the present invention, the system including: a display unit 100 in which a plurality of through holes 101 is formed in a predetermined array; an upper block 200 provided below each through holes 101 and vertically moving whereby an upper protrusion 210 thereof upwardly protrudes above the through hole 101 when the upper block 200 upwardly moves; an upper support block 300 fixing the upper block 200 in a row unit by horizontally moving; a lower block 400 provided below each upper block 200 and vertically moving, and upwardly pushing the upper block 200 when the lower block 400 upwardly moves; an elastic unit 500 provided below each lower block 400 and providing force to upwardly push the lower block 400; and a lower adjustment unit 600 controlling the lower block 400 in a column unit not to protrude up to a predetermined height; a row driving unit 800 horizontally moving the upper support block 300; a column driving unit 850 horizontally moving the lower adjustment unit 600; and a controller 900 controlling the row driving unit 800 and the column driving unit 850, wherein the controller 900 fixes the upper protrusions 210 in a row unit by protruding the upper protrusion 210 in a column unit to which the upper protrusion 210 to be protruded belongs of the row to be fixed, and by fixing the corresponding row.

### Advantageous Effects

According to a display module for visually impaired persons, a display system for visually impaired persons display system for visually impaired persons, and a control method therefor according to an embodiment of the present invention, information such as Braille words, figures, and images is displayed by operating a lower adjustment unit and an upper support block in row and column units. Accordingly, a configuration for the same becomes simple, and a control thereof becomes convenient by minimizing a number of units to be controlled when displaying information by using protrusions (conventionally, n*m units are operated, but in the present invention, n+m units are operated).

In addition, an upper block may be manufactured in a simple form by forming a movement shaft portion, an upper-end upward movement stopper, an upper column, and a holding portion in an upper block whereby the upper block may vertically move while the upper support block is coupled therewith.

In addition, by forming upper lower part movement limiting portion in the upper block, there is an effect of preventing the upper-end upward movement stopper from being damaged, and preventing the upper block from protruding from a through hole more than necessary.

In addition, by forming a moving slot in the upper support block, the upper support block may be manufactured in a simple form whereby the upper support block fixes the upper block.

In addition, a lower block may be manufactured in a simple form by forming a lower upper part movement limiting port, a lower column, a lower-end downward movement stopper (430) formed to extend from a lower part of the lower column, and a first inclined portion whereby the lower block may vertically move while the lower adjustment unit is coupled therewith.

In addition, the lower end part movement limiting portion may be manufactured in a simple form by forming an elastic coupling portion having a groove or protrusion form.

In addition, by providing a housing in which an upper guide slot and a lower guide slot are formed, a structure that guides horizontal movements of the upper support block and the lower adjustment unit and guiding vertical movements of the upper block and the lower block may be easily manufactured.

### BRIEF DESCRIPTION OF THE DRAWINGS

FIG. 1 is a perspective view showing a movement relationship of a display module for visually impaired persons according to an embodiment of the present invention.

FIG. 2 is an exploded perspective view of FIG. 1.

FIG. 3 is an example view showing another upper block of the display module for visually impaired persons according to an embodiment of the present invention.

FIG. 4 is an example view of showing another upper block and upper support block of the display module for visually impaired persons according to an embodiment of the present invention.

FIG. 5 is an example view showing another upper block and upper support block of the display module for visually impaired persons according to an embodiment of the present invention.

FIG. 6 is an example view showing the upper block of FIG. 1.

FIGS. 7 to 9 are cross-sectional views showing operational relationships between the upper block and the upper support block of FIG. 1.

FIGS. 10 and 11 are perspective views of a lower block of FIG. 1.

FIG. 12 is a perspective view of a lower adjustment unit of FIG. 1.

FIGS. 13 to 15 are planar views showing operational relationships of FIG. 1.

FIG. 16 is a cutaway exploded perspective view showing where the display module for visually impaired persons according to an embodiment of the present invention is stored in a housing.

FIG. 17 is a conceptual view of the display part that is controlled by a display system for visually impaired persons according to an embodiment of the present invention.

FIG. 18 is a conceptual view of the display system for visually impaired persons which is controlled in a controlling method for a display system for visually impaired persons according to an embodiment of the present invention.

FIG. 19 is a flowchart of the control method for the display system for visually impaired persons according to an embodiment of the present invention.

FIGS. 20 and 21 are example views showing a process of fixing a first row of the display part of FIG. 2.

FIGS. 22 and 23 are example views showing a process of fixing a second row of the display part of FIG. 2.

FIG. 24 is an example view showing a last status where all rows are fixed.

FIG. 25 is a conceptual view showing a display system for visually impaired persons controlled in the control method for visually impaired persons according to an embodiment of the present invention in which dual row driving units and dual column driving units are provided.

### BEST MODE

As the present invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention.

It will be understood that when an element is referred to as being “connected” or “coupled” to another element, it can be directly connected or coupled to the other element or intervening elements may be present

In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular example embodiments only and is not intended to be limiting of the present inventive concept. As used herein, the singular forms “a”, “an”, and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein

Hereinafter, exemplary embodiments of the invention will be described in detail with reference to the accompanying drawings. First of all, the terminologies or words used in the description and the claims of the present invention should not be interpreted as being limited merely to common and dictionary meanings. On the contrary, they should be interpreted based on the meanings and concepts of the invention in compliance with the scope of the invention on the basis of the principle that the inventor(s) can appropriately define the terms in order to describe the invention in the best way. In addition, unless otherwise stated, technical and scientific terms as used herein have a meaning generally understood by those skilled in the art. Descriptions of known functions and constructions which may unnecessarily obscure the subject matter of the present invention will be omitted. The exemplary embodiments of the present invention to be described below are provided by way of example so that the idea of the present invention can be sufficiently transferred to those skilled in the art to which the present invention pertains. Therefore, the present invention is not limited to the exemplary embodiments set forth herein but may be modified in many different forms. In addition, throughout the specification, like reference numerals denote like elements. In the drawings, it is to be noted that the same elements or parts are denoted by the same reference numerals whenever possible.

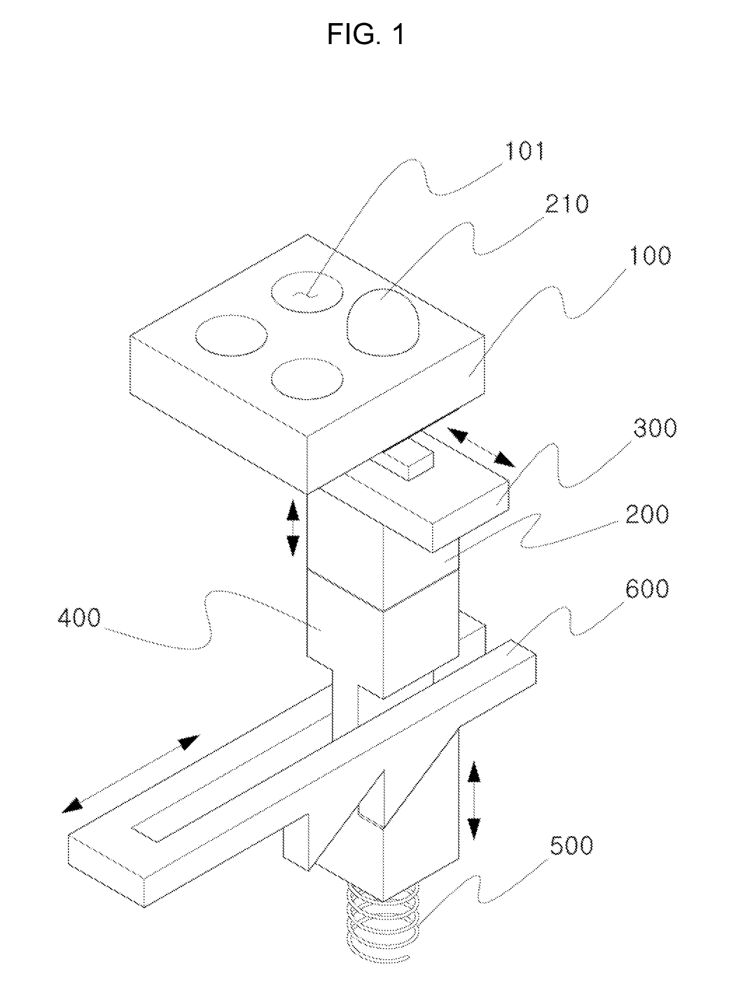

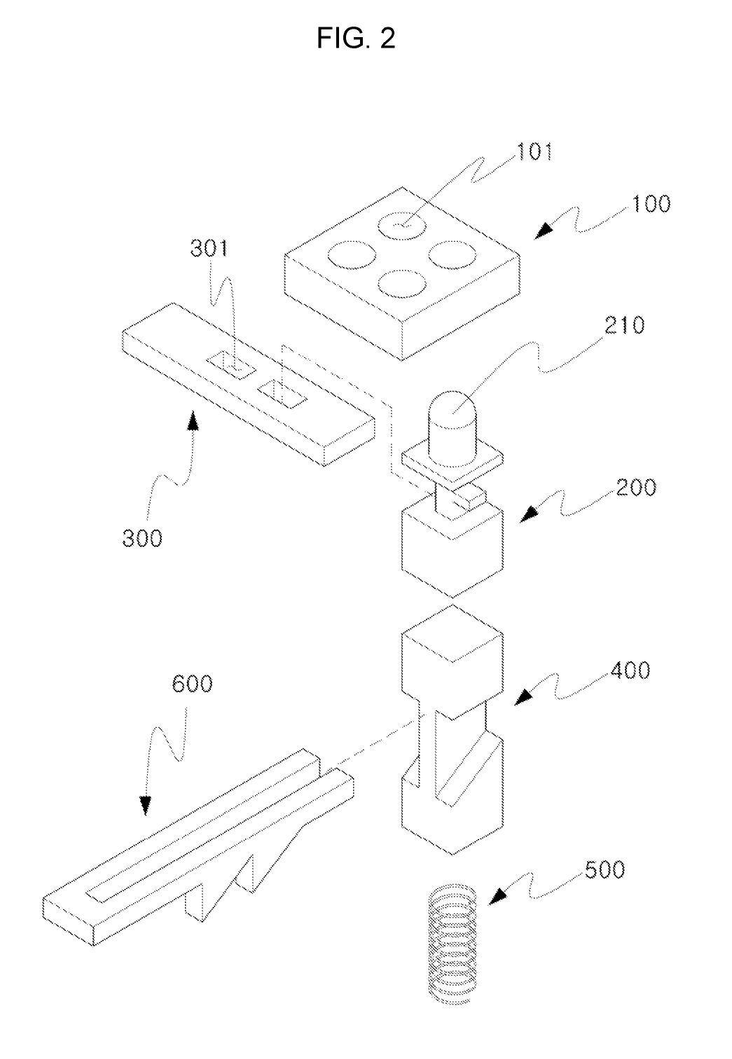

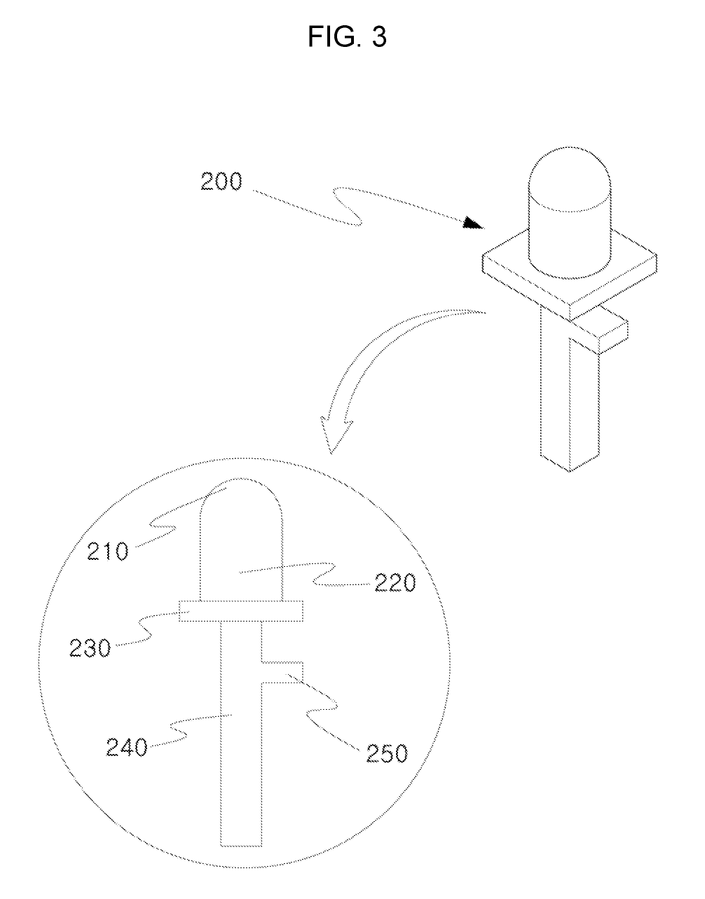

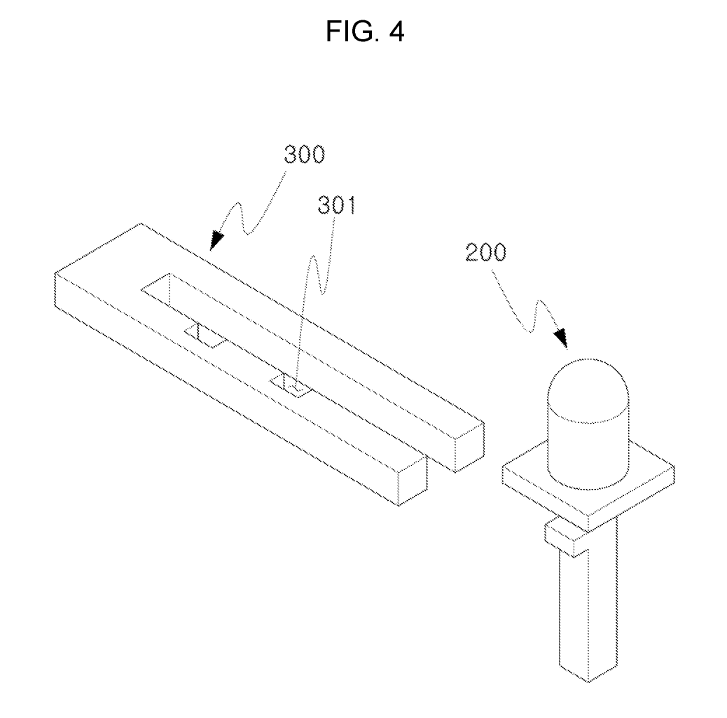

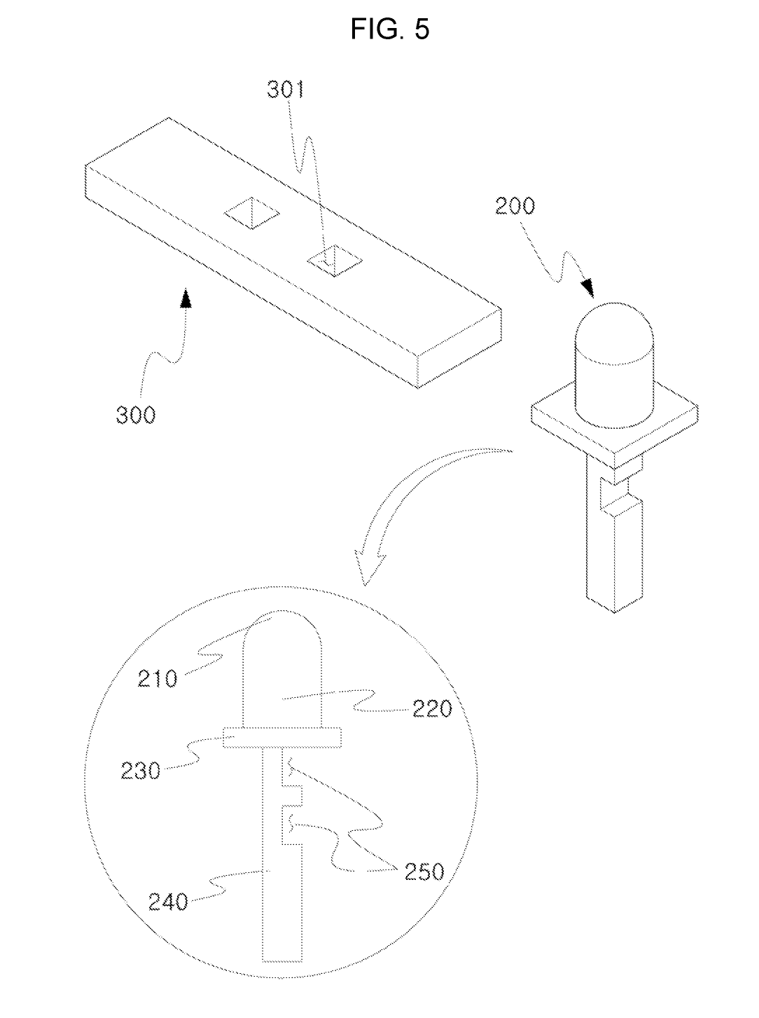

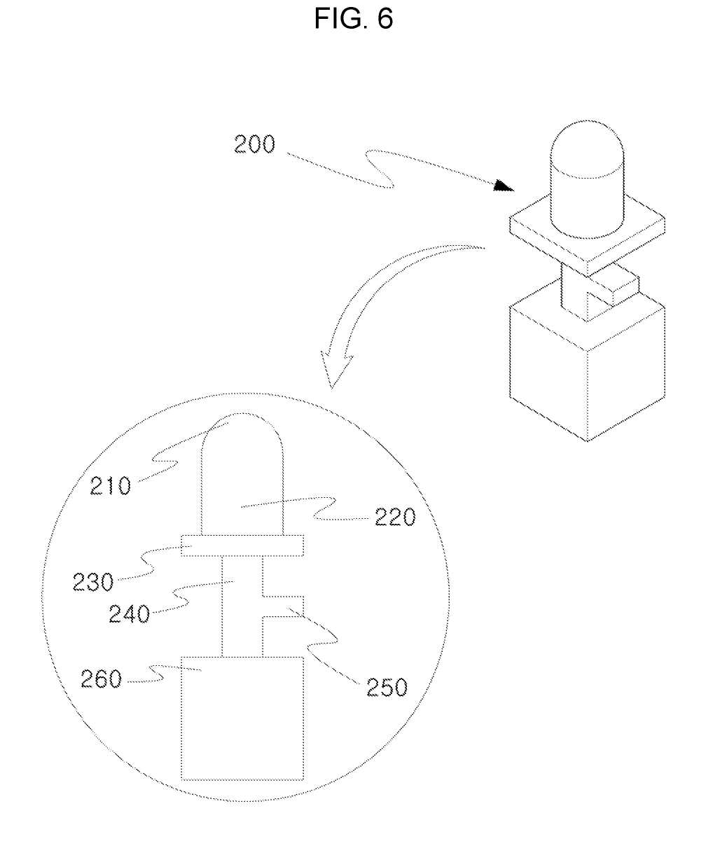

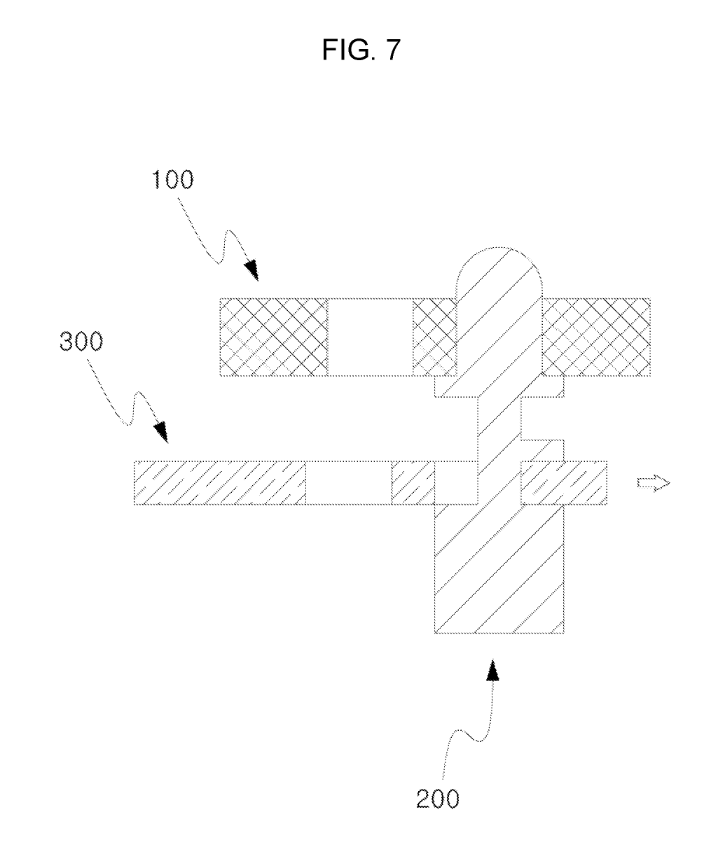

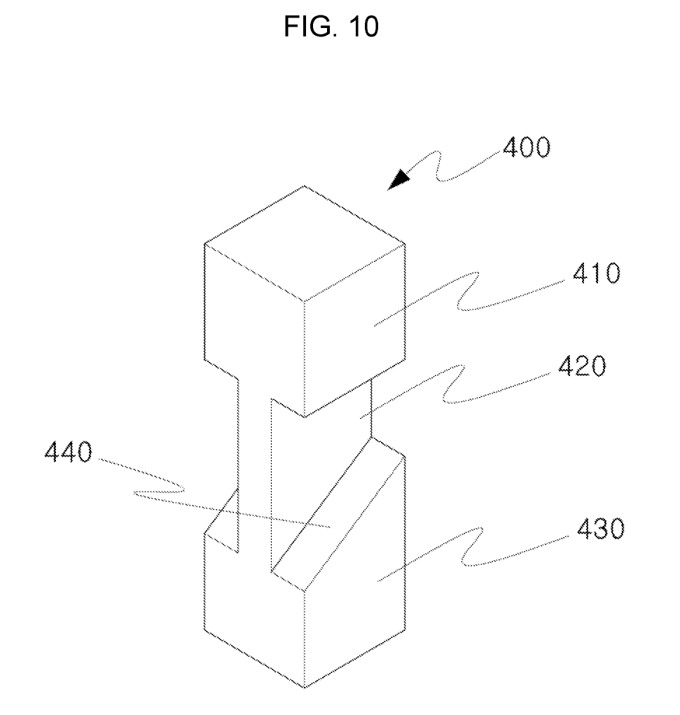

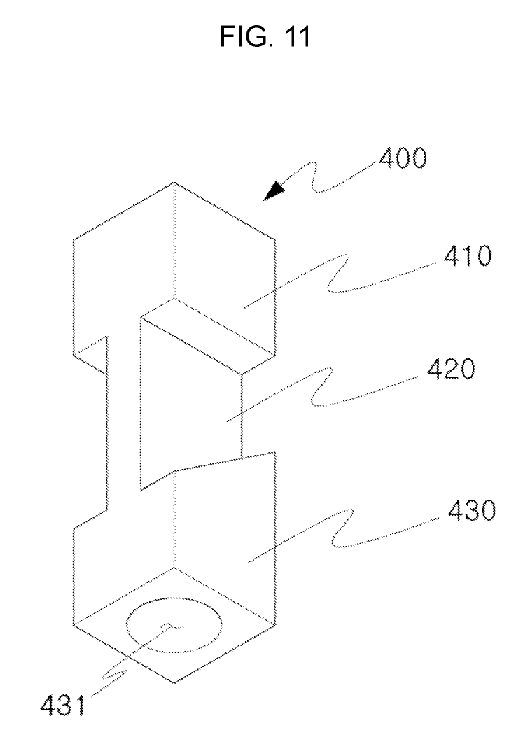

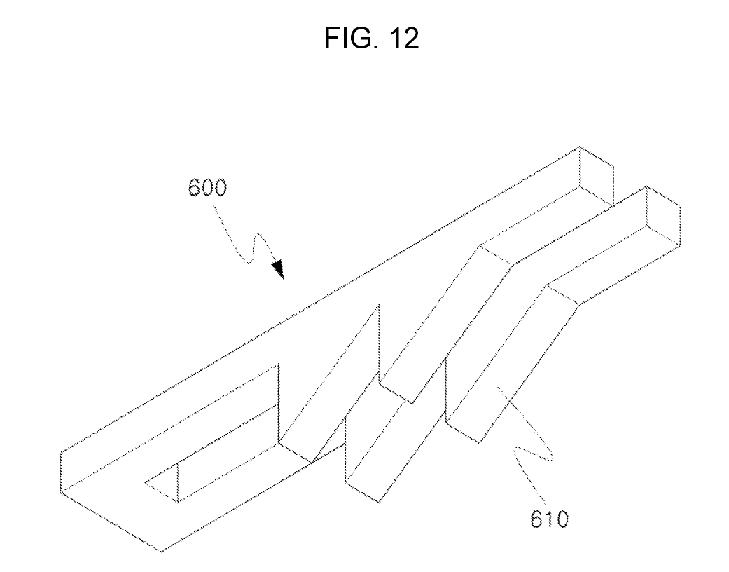

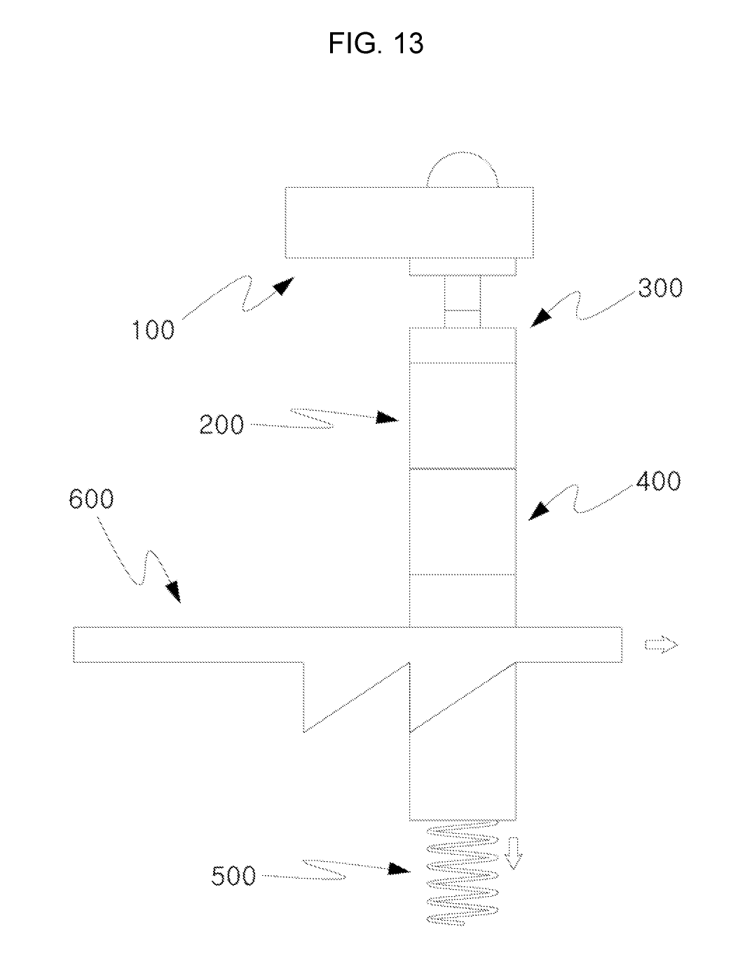

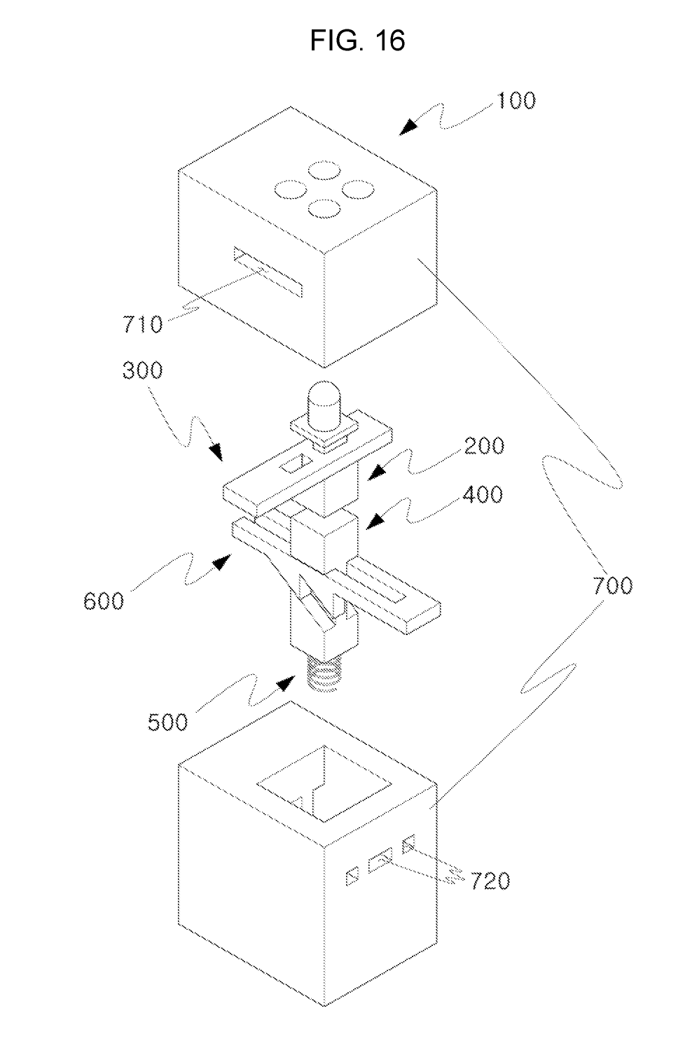

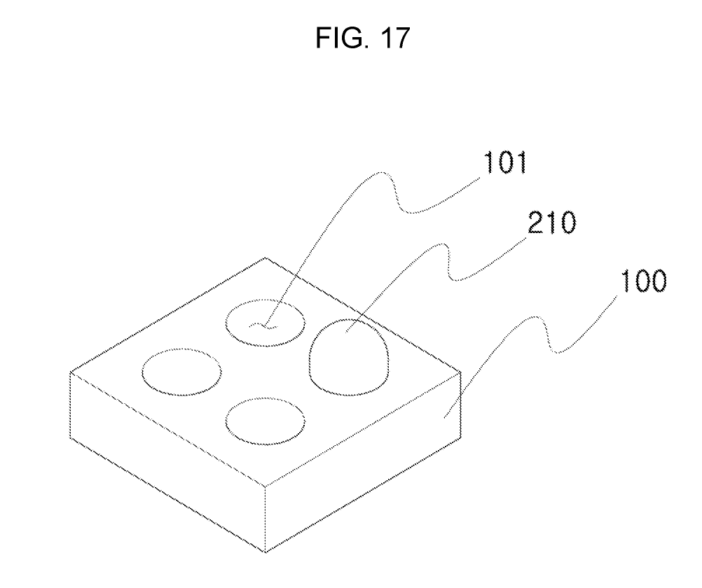

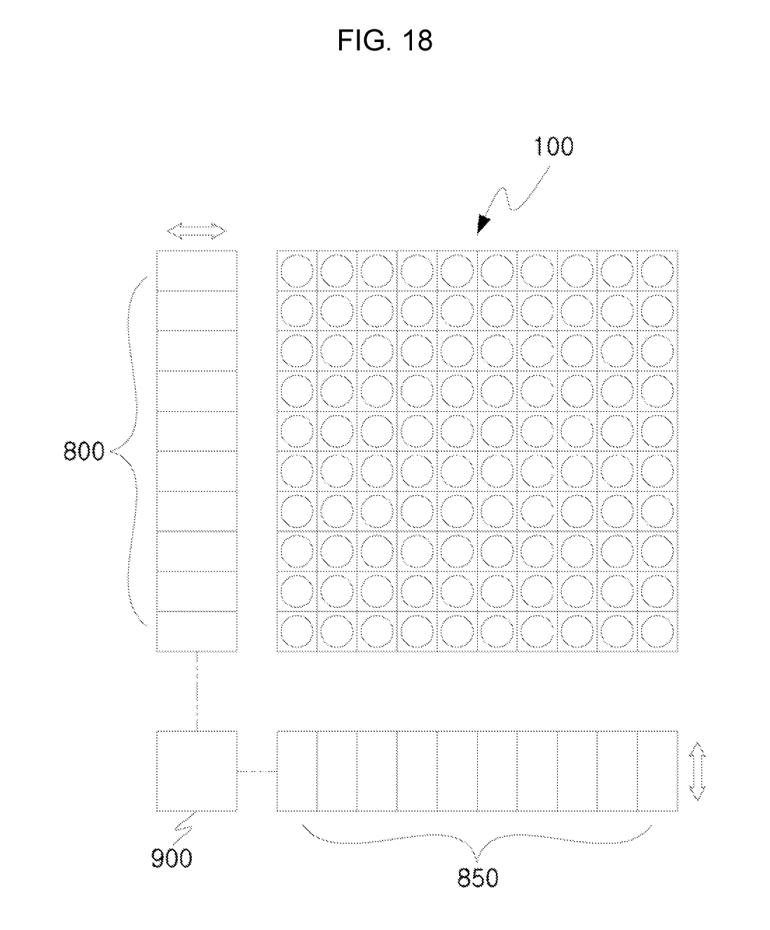

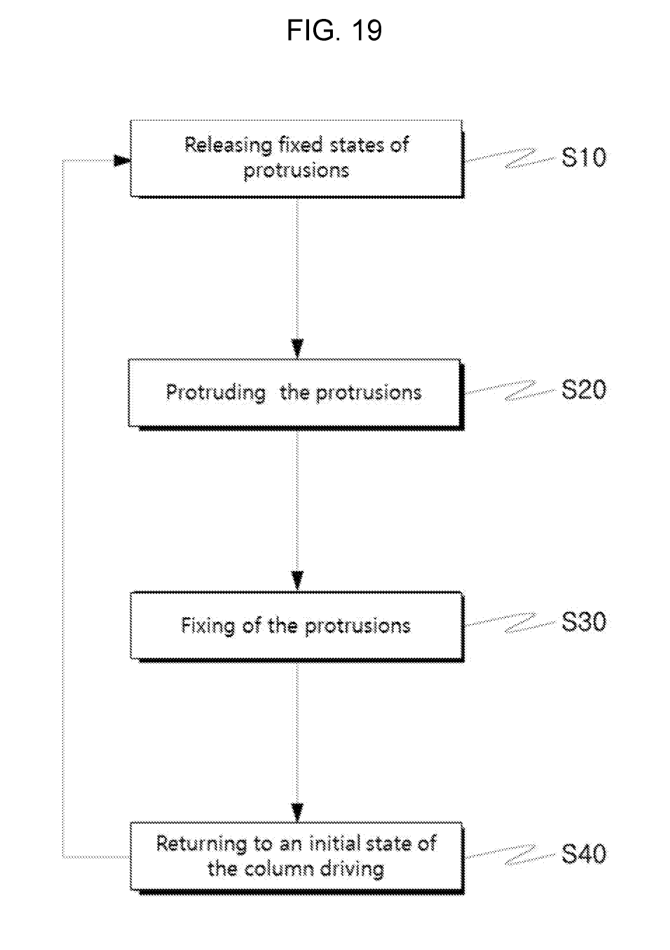

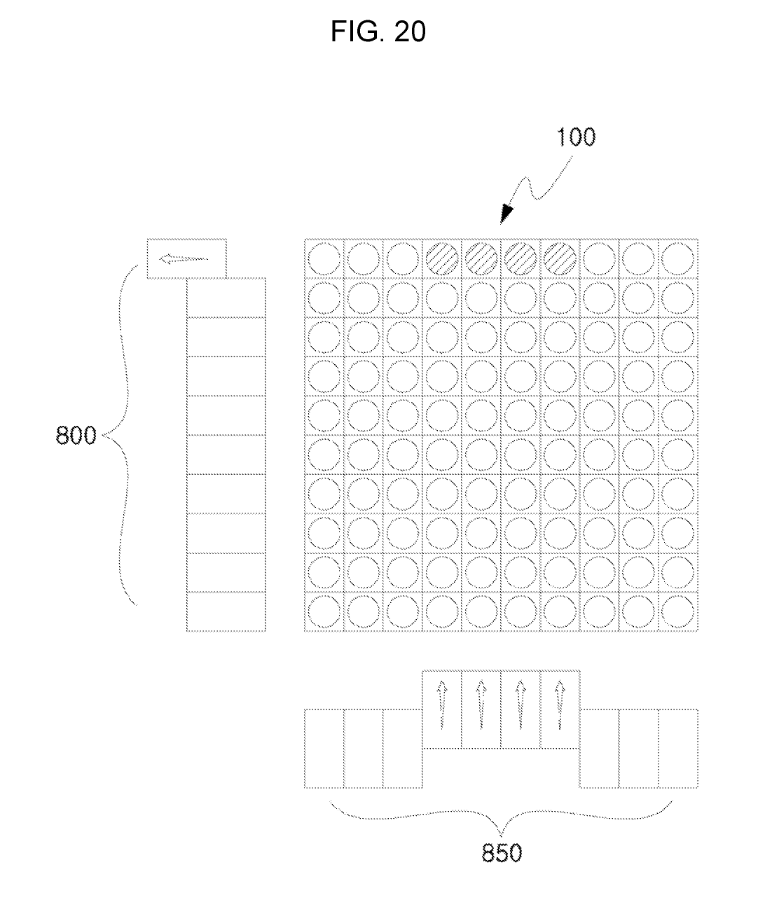

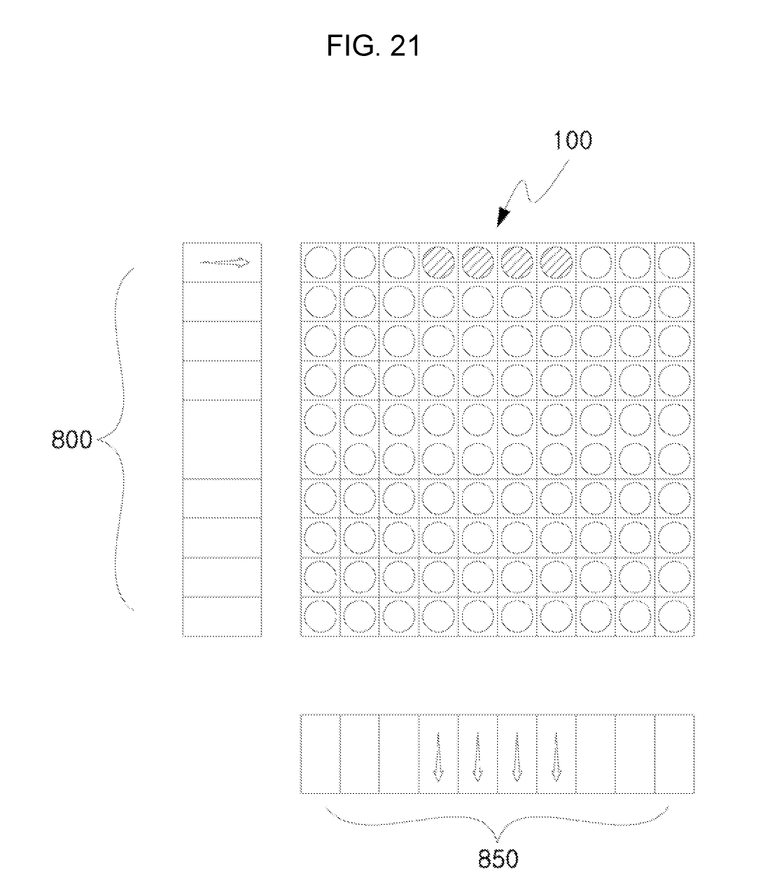

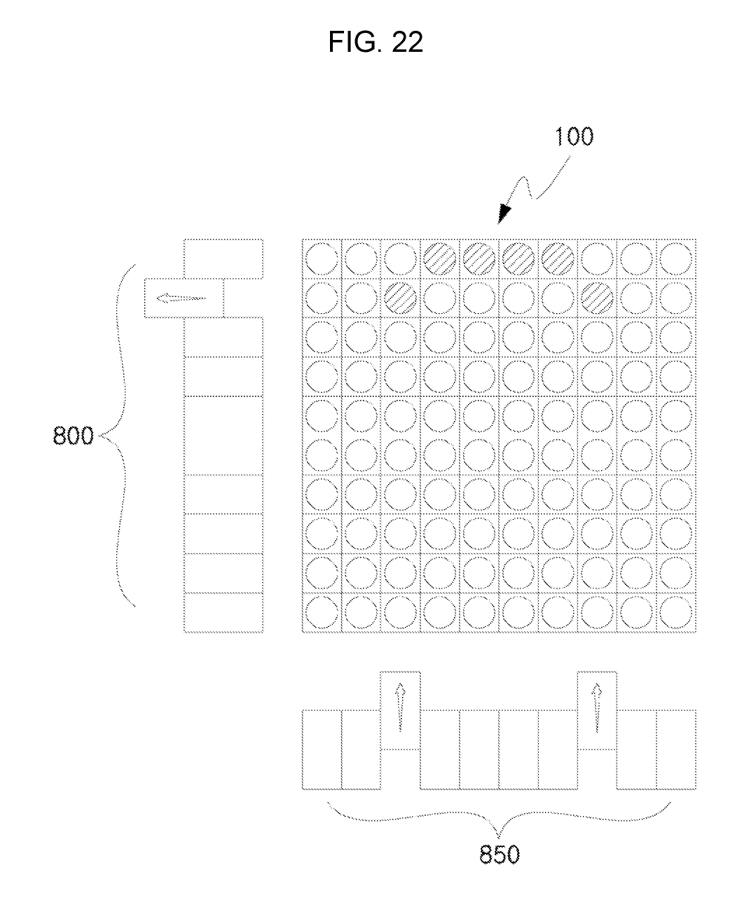

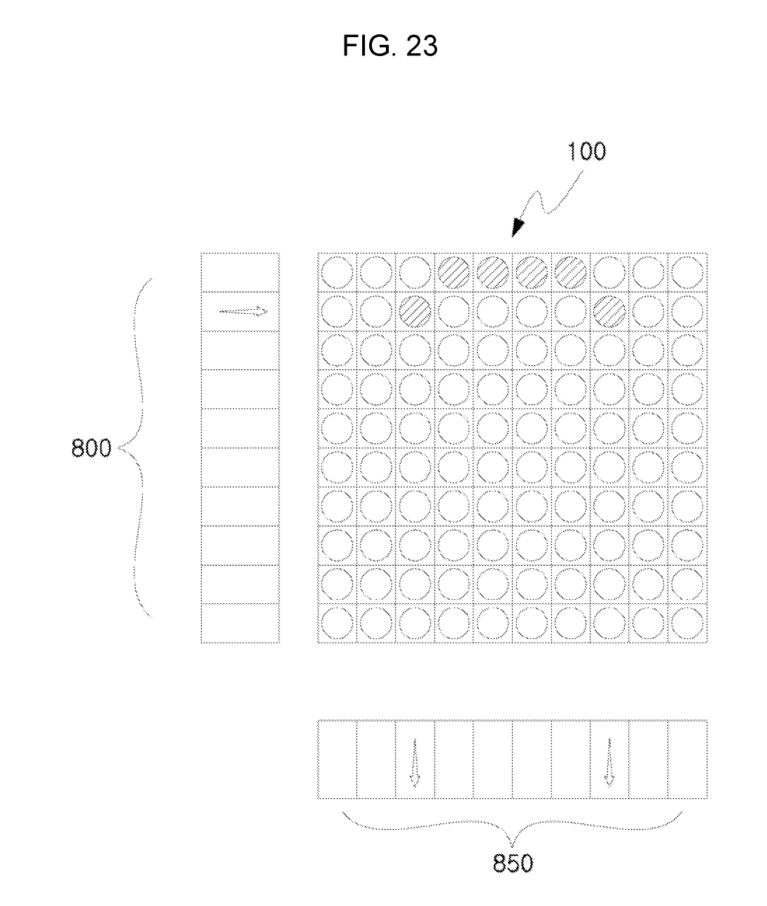

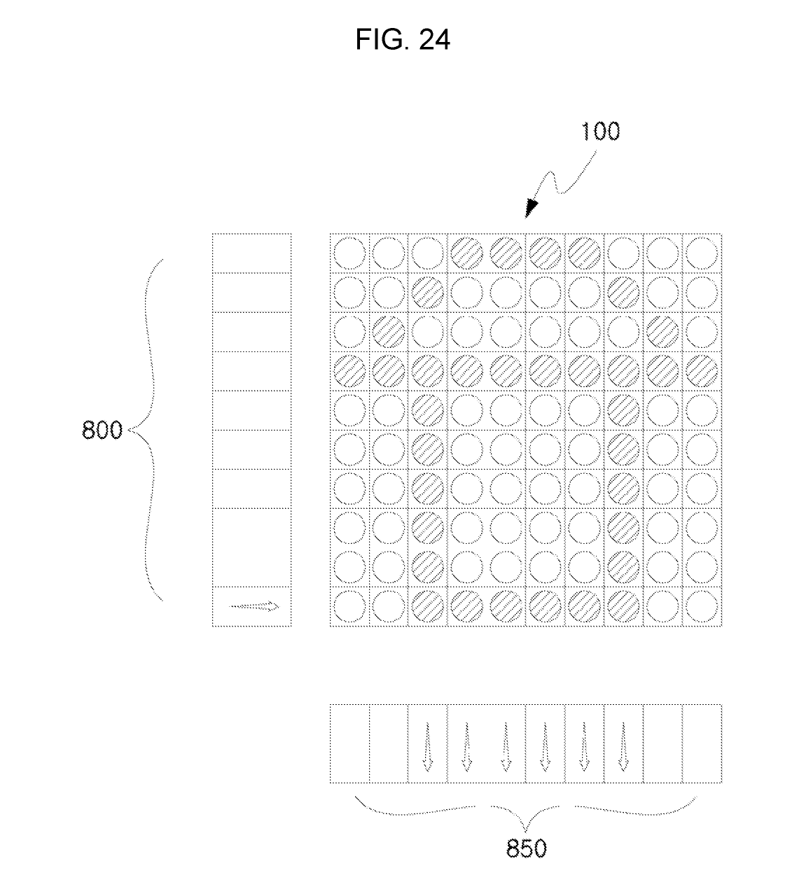

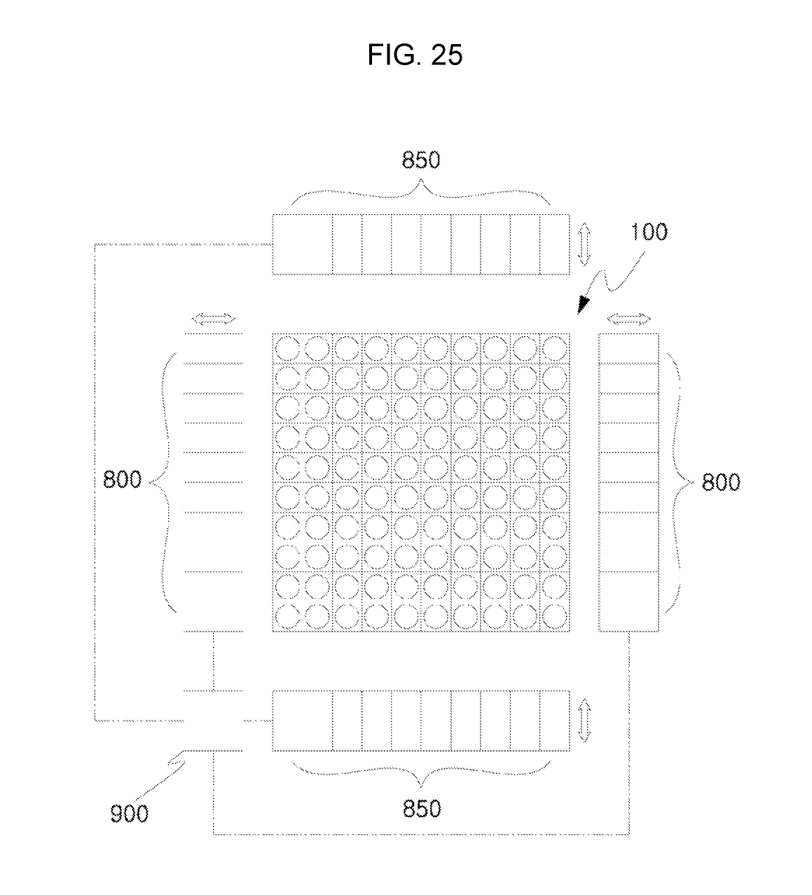

FIG. 1 is a perspective view showing a movement relationship of a display module for visually impaired persons according to an embodiment of the present invention, FIG. 2 exploded perspective view of FIG. 1, FIG. 3 is an example view showing another upper block of the display module for visually impaired persons according to an embodiment of the present invention, FIG. 4 is an example view of showing another upper block and upper support block of the display module for visually impaired persons according to an embodiment of the present invention, FIG. 5 is an example view showing another upper block and upper support block of the display module for visually impaired persons according to an embodiment of the present invention, FIG. 6 is an example view showing the upper block of FIG. 1, FIGS. 7 to 9 are cross-sectional views showing operational relationships between the upper block and the upper support block of FIG. 1, FIG. 10 and FIG. 11 are perspective views of a lower block of FIG. 1, FIG. 12 is a perspective view of a lower adjustment unit of FIG. 1, FIGS. 13 to 15 are planar views showing operational relationships of FIG. 1, FIG. 16 is a cutaway exploded perspective view showing where the display module for visually impaired persons according to an embodiment of the present invention is stored in a housing, FIG. 17 is a conceptual view of the display part that is controlled by a display system for visually impaired persons according to an embodiment of the present invention, FIG. 18 is a conceptual view of the display system for visually impaired persons which is controlled in a controlling method for a display system for visually impaired persons according to an embodiment of the present invention, FIG. 19 is a flowchart of the control method for the display system for visually impaired persons according to an embodiment of the present invention, FIGS. 20 to 21 are example views showing a process of fixing a first row of the display part of FIG. 2, FIG. 22 to FIG. 23 are example views showing a process of fixing a second row of the display part of FIG. 2, FIG. 24 is an example view showing a last status where all rows are fixed, and FIG. 25 is a conceptual view showing a display system for visually impaired persons controlled in the control method for visually impaired persons according to an embodiment of the present invention in which dual row driving units and dual column driving units are provided.

In order to display information such as Braille words, figures, and images by vertically moving a plurality of protrusions, conventionally, the plurality of protrusions is respectively controlled. However, in the present invention, a number of units to be controlled is minimized by controlling the plurality of protrusions in row and column units. Accordingly, the present invention provides a display module for visually impaired persons, a display system for visually impaired persons, and a control method thereof which have a simple configuration, and are easy to control.

In order to aid understanding, for example, a display unit 100 of the figure used in the following description is formed with four through holes 101, but it is not limited thereto. In addition, it should be noted that single upper block 200, upper support block 300, lower block 400, elastic unit 500, and lower adjustment unit 600 are shown.

In addition, the following description is described based on a row and a column shown in the figure, the row may be a vertical side group as well as a horizontal side group. In other words, when the row refers to a horizontal side group, the column refers to a vertical side group. Alternatively, when the row refers to vertical side group, the column refers to a horizontal side group. In addition, a direction in the row is represented from the left to right side, and a direction in the column is represented from the upper to lower side.

As shown in FIG. 1 to FIG. 2, a display module for visually impaired persons according to an embodiment of the present invention includes a display unit 100, an upper block 200, an upper support block 300, a lower block 400, an elastic unit 500, and a lower adjustment unit 600. The upper support block 300 fixes the upper block 200 in a row or column unit, and the lower adjustment unit 600 controls the lower block 400 in a column or row unit not to protrude up to a predetermined height.

In other words, when the upper support block 300 fixes the upper block 200 in a row unit, the lower adjustment unit 600 controls the lower block 400 not to protrude up to a predetermined height in a column unit.

In addition, when the upper support block 300 fixes the upper block 200 in a column unit, the lower adjustment unit 600 controls the lower block 400 not to protrude up to a predetermined height in a row unit.

In the display unit 100, a plurality of through holes 101 is formed in a predetermined array.

In the display unit 100, a plurality of through holes 101 is formed in a predetermined array to display information such as Braille words, figures, and images so that a plurality of protrusions protrudes the plurality of through holes 101. For example, the plurality of through holes 101 may be formed in various arrays such as 100 rows*50 columns.

The upper block 200 is provided below each through hole 101, vertically moves, and an upper protrusion 210 thereof protrudes to above the through hole 101 when the upper block 200 upwardly moves.

The upper protrusion 210 may be protruded upward or may be recessed into the through hole 101 as the upper block 200 vertically moves.

The upper support block 300 fixes the upper block 200.

The upper support block 300 may fix the upper block 200 while the upper protrusion 210 of the upper block 200 is protruded above the through hole 101, or may fix the upper block 200 while the upper protrusion 210 of the upper block 200 is recessed into the through hole 101.

The lower block 400 is provided below each upper block 200, vertically moves, and upwardly pushes the upper block 200 when the lower block 400 upwardly moves.

The lower block 400 upwardly pushes the upper block 200 which is not fixed by the upper support block 300.

The elastic unit 500 is provided below each lower block 400, and provides force for upwardly pushing the lower block 400.

The lower adjustment unit 600 controls the lower block 400 not to protrude up to a predetermined height.

In other words, when the lower adjustment unit 600 upwardly pushes the lower block 400 up to a maximum height, the lower block 400 upwardly moves by the force of the elastic unit 500. Accordingly, the lower block 400 may upwardly push the upper block 200. The upper block 200 that is not fixed by the upper support block 300 may be upwardly pushed. Then, the upper block 200 may be fixed by the upper support block 300.

In FIG. 1 to FIG. 2, a movement direction of the upper support block 300 is perpendicular to a movement direction of the lower adjustment unit 600, but the present invention is not limited thereto. When the upper support block 300 fixes the upper block 200 in a row or column unit, and the lower adjustment unit 600 controls the lower block 400 not to protrude up to a predetermined height in a column or row unit, movement directions of the upper support block 300 and the lower adjustment unit 600 may be variably implemented.

In addition, the display module for visually impaired persons according to an embodiment of the present invention may be manually or automatically operated.

As shown in FIG. 3 to FIG. 5, the upper block 200 of the display module for visually impaired persons according to an embodiment of the present invention may include an upper protrusion 210, a movement shaft portion 220, an upper-end upward movement stopper 230, an upper pillar portion 240, and an engagement portion 250.

The movement shaft portion 220 is formed to extend from a lower part of the upper protrusion 210, to have a form corresponding to the through hole 101, and to have a column shape having a horizontal cross-sectional area smaller than a horizontal cross-sectional area of the through hole 101.

The movement shaft portion 220 reciprocates interior of the through hole 101. Herein, the upper block 200 upwardly moves by force upwardly pushed by the lower block 400, and the upper block 200 moves downwardly by gravity. Accordingly, in order to prevent a situation where the movement shaft portion 220 is sandwiched in the through hole 101 so that the movement shaft portion 220 cannot downwardly move by gravity, it is preferable to form the movement shaft portion 220 to have a form corresponding to the through hole 101, and to have a horizontal cross-sectional area smaller than a horizontal cross-sectional area of the through hole 101.

The upper-end upward movement stopper 230 is formed to extend from a lower part of the movement shaft portion 220, and to have a column shape having a horizontal cross-sectional area greater than the horizontal cross-sectional area of the through hole 101.

The upper-end upward movement stopper 230 is provided below the display unit 100, and functions to prevent the upper block 200 from protruding through the through hole 101 more than necessary.

The upper pillar portion 240 is formed to extend from a lower part of the upper-end upward movement stopper 230, and to have a column shape having a horizontal cross-sectional area smaller than the horizontal cross-sectional area of the upper-end upward movement stopper 230.

The upper pillar portion 240 is a configuration for vertically moving the upper block 200, and may vertically move while the upper support block 300 that will be described later is coupled therewith.

The engagement portion 250 is formed on a side surface of the upper pillar portion 240 by being protruded (refer to FIG. 3 to FIG. 4) or depressed (refer to FIG. 3 to FIG. 4) in a horizontal direction.

The engagement portion 250 is a configuration for fixing the upper block 200 by using the upper support block 300 that will be described later.

As shown in FIG. 6, the display module for visually impaired persons according to an embodiment of the present invention may further include an upper-end downward movement stopper 260 formed to extend from a lower part of the upper pillar portion 240, and to have a column shape having a horizontal cross-sectional area greater than the horizontal cross-sectional area of the upper pillar portion 240.

The upper-end downward movement stopper 260 bumps into the upper support block 300 that will be described later so that the upper block 200 may not protrude through the through hole 101 more than necessary. The above function is identical to the function of the upper-end upward movement stopper 230, and the upper-end downward movement stopper 260 prevents the upper-end upward movement stopper 230 from being damaged, and simultaneously prevents the upper block 200 from protruding through the through hole 101 more than necessary even though the upper-end upward movement stopper 230 is damaged.

It is preferable that cross-sectional forms of the upper-end upward movement stopper 230 and the upper-end downward movement stopper 260 are identical. This is for facilitating vertical reciprocating movements of the upper block 200 in a housing that will be described later since the interior of the housing is formed in a basic column shape.

As shown in FIG. 2, FIG. 4, and FIG. 5, in the display module for visually impaired persons according to an embodiment of the present invention, the upper support block 300 is coupled with the upper block 200 so that the upper support block 300 horizontally moves based on the upper pillar portion 240, and includes a movement slot 301 so that the upper pillar portion 240 vertically moves therein.

The movement slot 301 is formed such that the engagement portion 250 passes as the upper support block 300 moves, or is formed such that the engagement portion 250 cannot pass as the upper support block 300 moves.

For example, in FIG. 2, when the upper support block 300 moves to a direction where the engagement portion 250 is protruded, the upper block 200 may vertically move. Alternatively, when the upper support block 300 moves to a direction opposite where the engagement portion 250 is protruded, the upper block 200 is fixed.

In FIG. 4, the engagement portion 250 may move toward the movement slot 301 when positions of the engagement portion 250 and the movement slot 301 are in association therewith.

In FIG. 5, when the upper support block 300 moves to a direction opposite to where the engagement portion 250 is recessed, the upper block 200 may vertically move. Alternatively, when the upper support block 300 moves to a direction where the engagement portion 250 is recessed, the upper block 200 is fixed.

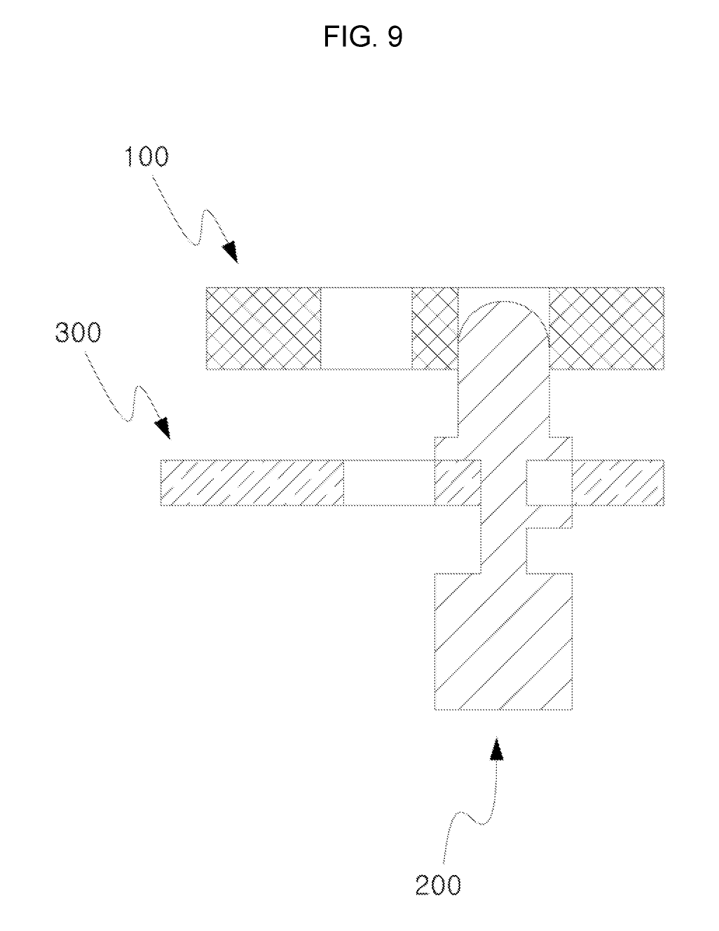

Describing operations of the upper block 200 and the upper support block 300 of the display module for visually impaired persons according to an embodiment of the present invention with reference to FIGS. 7 and 9,

FIG. 7 shows a cross-sectional view where the upper block 200 is fixed by the upper support block 300.

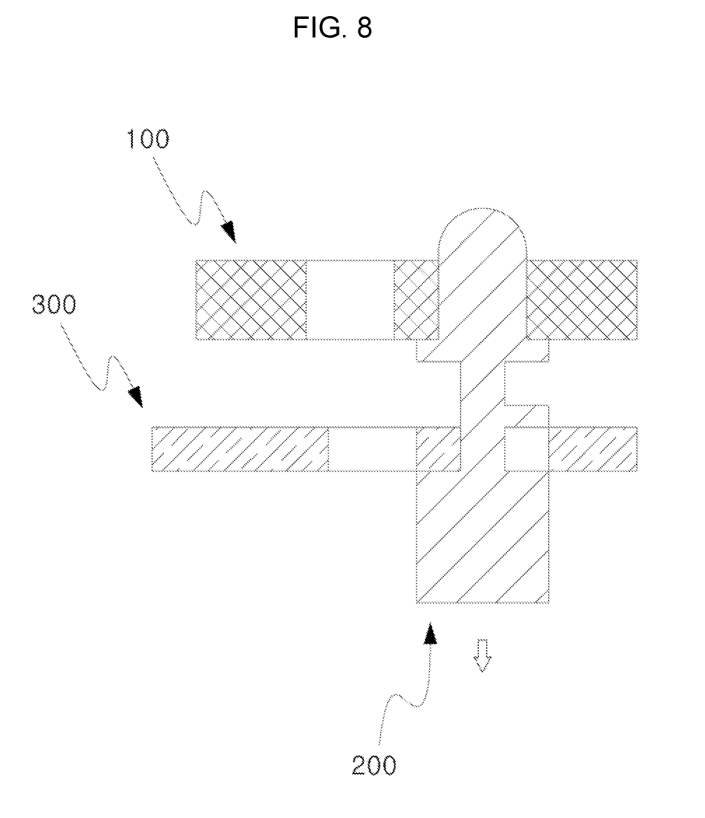

When the upper block 200 of FIG. 7 is pushed to the right side as FIG. 8 so that it becomes a state as shown in FIG. 9, the upper block 200 moves downwardly by gravity as shown in FIG. 9.

In other words, when the upper block 200 is not fixed by the upper support block 300, the upper block 200 upwardly moves since the lower block 400 upwardly pushes the upper block 200. Otherwise, the upper block 20 moves downwardly by gravity.

As shown in FIGS. 10 and 11, the lower block 400 of the display module for visually impaired persons according to an embodiment of the present invention may include a lower-end upward movement stopper 410, a lower pillar portion 420, a lower-end downward movement stopper 430, and a first inclined portion 440.

The lower-end upward movement stopper 410 is formed to have a pillar shape.

The lower-end upward movement stopper 410 functions to prevent the lower block 400 from downwardly moving more than necessary by being bumped into the lower adjustment unit 600 that will be described later.

The lower pillar portion 420 is formed to extend from a lower part of the lower-end upward movement stopper 410, and to have a horizontal cross-sectional area smaller than a horizontal cross-sectional area of the lower-end upward movement stopper 410.

The lower pillar portion 420 is a configuration for vertically moving the lower block 400, and may vertically move while the lower adjustment unit 600 that will be described later is coupled therewith.

The lower-end downward movement stopper 430 is formed to extend from a lower part of the lower pillar portion 420, and to have a horizontal cross-sectional area greater than the horizontal cross-sectional area of the lower pillar portion 420.

The lower-end downward movement stopper 430 functions to prevent the lower block 400 from upwardly moving more than necessary by being bumped into the lower adjustment unit 600 that will be described later.

The first inclined portion 440 is formed to be upwardly inclined from the lower-end downward movement stopper (430).

The first inclined portion 440 is a configuration for downwardly pushing the lower block 400, and is formed with an included surface so that the lower block 400 vertically moves as the lower adjustment unit 600 that will be described later horizontally moves.

It is preferable that cross-sectional forms of the lower-end upward movement stopper 410 and the lower-end downward movement stopper 430 are identical. This is for facilitating vertical reciprocating movement of the upper block 200 in a housing that will be described later since the interior of the housing is formed in a basic column shape.

As shown in FIG. 12, in the display module for visually impaired persons according to an embodiment of the present invention, the lower adjustment unit 600 is coupled with the lower block 400 so that the lower adjustment unit 600 horizontally moves based on lower pillar portion 420, and includes a second inclined portion 610 formed to have a form corresponding to the first inclined portion 440. The first inclined portion 440 and the second inclined portion 610 face and are in contact with each other so that the lower block 400 moves downwardly as the lower adjustment unit 600 horizontally moves.

The lower adjustment unit 600 includes a second inclined portion 610 formed to have an inclined surfaces corresponding to the first inclined portion 440. The second inclined portion 610 is a configuration for vertically moving the lower block 400 as the lower adjustment unit 600 horizontally moves. As shown in FIG. 12, the second inclined portion 610 may be formed to be protruded, or may be formed to be depressed.

In addition, force for upwardly moving the lower block 400 by the elastic unit 500 is provided to the lower block 400, thus the lower block 400 upwardly moves until to be bumped into the lower adjustment unit 600. Herein, a height of the lower block 400 may be adjusted by horizontally moving the lower adjustment unit 600.

As shown in FIG. 11, in the display module for visually impaired persons according to an embodiment of the present invention, an elastic coupling portion 431 is formed to have a groove or protrusion form in a lower part of the lower-end downward movement stopper 430 so that the elastic unit 500 is coupled therein.

In FIG. 11, an elastic coupling portion 431 formed with a groove form is shown, but the present invention is not limited thereto. The elastic coupling portion 431 may be formed to have a protrusion so that the elastic unit 500 is inserted thereto.

Describing an operation of the display module for visually impaired persons according to an embodiment of the present invention with reference to FIGS. 13 to 15,

FIG. 13 is a cross sectional view where the lower block 400 is upwardly pushed by the elastic unit 500.

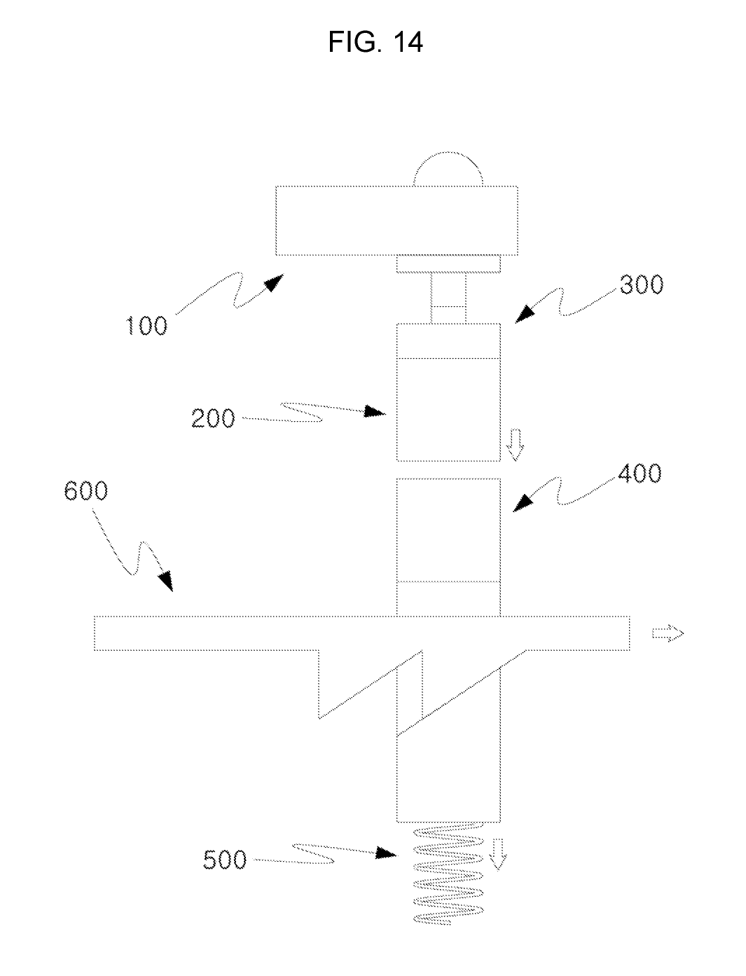

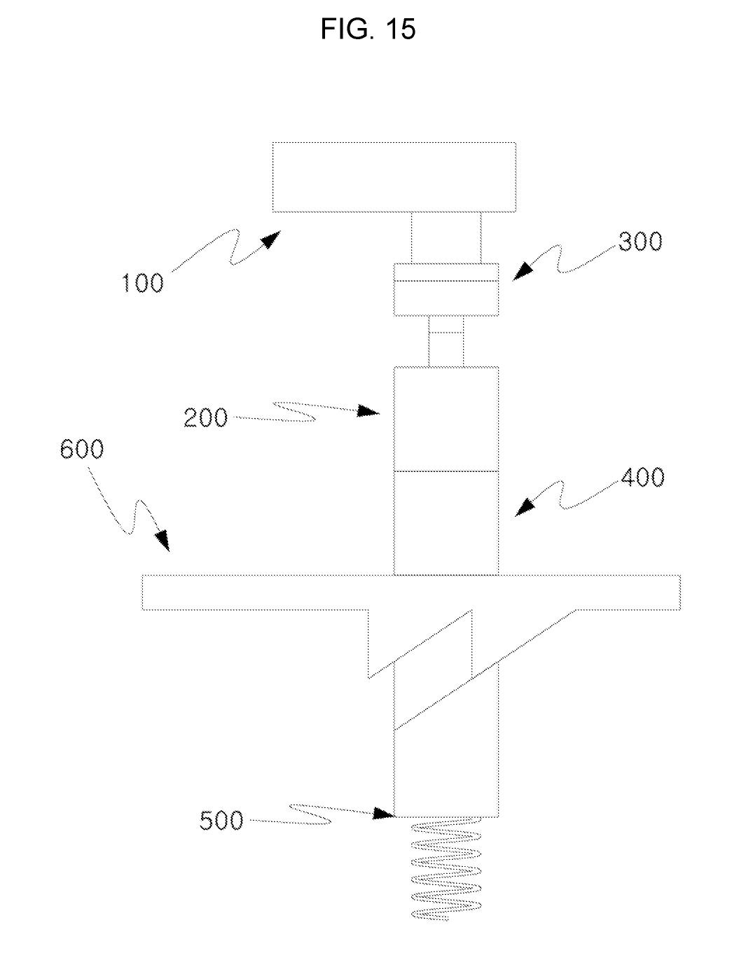

When the lower adjustment unit 600 of FIG. 13 is pushed to the right side as FIG. 14 so that it becomes a state as shown in FIG. 15, the upper block 200 moves downwardly by gravity as FIG. 15.

In other words, when the upper block 200 is not fixed by the upper support block 300, the upper block 200 moves downwardly by gravity when the lower adjustment unit 600 downwardly pushes the lower block 400.

Based on this, describing the entire operation of the display module for visually impaired persons with an example in which through holes 101 are formed in an array of 10 (rows)*10 (columns), the lower adjustment unit 600 controls the lower block 400 in a column unit, and the upper support block 300 controls the upper block 200 in a row unit,

Upper protrusions 210 of columns to be protruded in a first row are protruded by operating the lower adjustment unit 600, and the first row is fixed by operating the upper support block 300. Then, upper protrusions 210 of columns to be protruded in a second row are protruded are by operating the lower adjustment unit 600, and the second row is fixed by operating the upper support block 300.

By repeating the above process up to a tenth row, displaying of upper protrusions 210 of a 10 (rows)*10 (columns) is completed.

Accordingly, in order to express 10 (rows)*10 (columns), ten lower adjustment units 600 and ten upper support blocks 300 are required, thus the 10 (rows)*10 (columns) may be expressed by controlling twenty units.

As shown in FIG. 16, the display module for visually impaired persons according to an embodiment of the present invention may further include a housing 700 storing the upper block 200 and the lower block 400 therein, and storing the upper support block 300 and the lower adjustment unit 600 so that parts of respective first sides of the upper support block 300 and the lower adjustment unit 600 outwardly protrude.

The housing 700 may be formed to be integrated with the display unit 100, or may be formed to be dissembled into a plurality of parts when necessary.

The housing 700 is formed with an upper guide slot 710 whereby the upper support block 300 horizontally moves, and a horizontal height of the upper support block 300 is maintained, and a lower guide slot 720 whereby the lower adjustment unit 600 horizontally moves, and a horizontal height of the lower adjustment unit 600 is maintained.

It is preferable to maintain heights of the upper support block 300 and the lower adjustment unit 600 to be constant. For this, it is preferable to form the upper guide slot 710 for horizontal movements of the upper support block 300, and to form the lower guide slot 720 for horizontal movements of the lower adjustment unit 600 in the housing 700.

As shown in FIGS. 17 and 18, a control method for a display system for visually impaired persons according to an embodiment of the present invention, wherein the display system includes a display unit 100 in which a plurality of through holes 101 is formed in a predetermined array (refer to FIG. 1), a column driving unit 850 protruding upper protrusions 210 in a column unit above the display unit 100 according to a control command of a controller 900 (refer to FIG. 2), and a row driving unit 800 fixing the upper protrusions 210 in a row unit according to a control command of the controller 900 (refer to FIG. 2), includes,

As shown in FIG. 19, step S10 of releasing fixed states of protrusions, step S20 of protruding the protrusions, step S30 of fixing of the protrusions, and step S40 of returning to an initial state of the column driving. The steps S10 to S40 are sequentially repeatedly performed in accordance with an order of predetermined rows.

In step S10, fixed states of the upper protrusions 210 of a row to be displayed are released by driving the row driving unit 800.

This is because, the upper protrusions 210 are fixed in default.

In other words, in initial states, all upper protrusions 210 are in fixed states. Accordingly, in order to operate the upper protrusion 210, a fixed state of the upper protrusion 210 to be operated may be released, and the fixed state of the upper protrusion 210 may be released in a row unit.

In step S20, an upper protrusion 210 of a column to be displayed in which the fixed state thereof is released in step S10 is protruded to above the display unit 100 by driving the column driving unit 850.

In other words, in step S20, the upper protrusion 210 of the corresponding column is protruded by selecting an upper protrusion of a column to be protruded in the corresponding row based on a single row.

In step S30, the upper protrusions 210 in which the fixed states thereof are released in step S10 become fixed by driving the row driving unit 800.

In other words, in step S30, the row driving unit 800 returns to an initial state, thus the upper protrusion 210 of the corresponding row which is protruded in step S20 is fixed while the upper protrusion 210 is protruded, and the upper protrusion 210 of the corresponding row and which is not protruded is fixed while the upper protrusion 210 is not protruded.

In step S40, the column driving unit 850 driven in step S20 is returned to an initial state thereof.

When displaying 10 (rows)*10 (columns), an example of displaying a house shape as FIG. 24 by sequentially fixing from the first row will be described with reference to FIGS. 20 to 24.

The row driving unit 800 shown in FIGS. 20 to 24 performs operations of releasing fixed states of upper protrusions 210 by moving to the left side, and performs operations of fixing the upper protrusions 210 by moving to the right side. In addition, the column driving unit 850 performs operations of protruding up the upper protrusions 210 by moving to the upper side.

First, in order to release a fixed state of a first row, as shown in FIG. 20, in step S10, the fixed state of the first row is released by performing a control command of releasing the fixed state of the first row by the row driving unit 800.

Then, as shown in FIG. 20, in step S20, four columns are protruded by performing a control command that protrudes four columns by the column driving unit 850.

Then, as shown in FIG. 21, in step S30, the first row becomes fixed by performing a control command that fixes the first row by the row driving unit 800.

Then, as shown in FIG. 21, in step S40, four column driving units 850 return to initial states thereof by performing a control command through which the column driving units 850 return to the initial state thereof by the column driving unit 850. Herein, since the first row is fixed, there is no change in upper protrusions 210 of the first row.

Then, in order to release a fixed state of a second row, as shown in FIG. 22, in step S10, the fixed state of the second row is released by performing a control command of releasing the fixed state of the second row by the row driving unit 800. Herein, since the first row is fixed, there is no change in upper protrusions 210 of the first row.

Then, as shown in FIG. 22, in step S20, two columns are protruded by performing a command that protrudes two columns by the column driving unit 850.

The, as shown in FIG. 23, in step S30, the second row is fixed by performing a control command that fixes the second row by the row driving unit 800.

Then, as shown in FIG. 23, in step S40, two column driving units 850 return to initial states thereof by performing a control command through which the column driving units 850 return to the initial state thereof by the column driving unit 850. Herein, since the first and second rows are fixed, there is no change in upper protrusions 210 of the first and second rows.

As described above, step S10 to step S40 are repeatedly performed for each row, and finally, the house shape shown in FIG. 24 is displayed.

This is for minimizing a number of units to be controlled by controlling the upper protrusions 210 in row and column units rather than controlling the respective upper protrusions 210.

When, N*M upper protrusions are respectively controlled, N*M driving units are required. However, in the present invention, N+M driving units are required, thus the entire system may become simple, and manufacturing cost thereof may be minimized.

Herein, protruding same columns such as fifth to ninth rows, a displaying time may be reduced by performing step S10 of releasing fixed states of the fifth to ninth rows and step S30 of fixing the fifth to ninth rows.

In addition, in order to reduce more the displaying time, the second, and the fifth to ninth rows may be controlled at the same time.

In the control method for the display system for visually impaired persons according to an embodiment of the present invention, an initialization of releasing the fixed state of the row fixed in step S30 may be available.

The row driving unit 800 functions to fix the upper protrusions 210 in a row unit, and may initialize a row to be updated to display new information. For this, the row driving unit 800 may initialize the fixed state of the row fixed by itself.

As shown in FIGS. 1 and 2, a display system for visually impaired persons according to an embodiment of the present invention includes a display unit 100, an upper block 200, an upper support block 300, a lower block 400, an elastic unit 500, a lower adjustment unit 600, a row driving unit 800, a column driving unit 850, and a controller 900. The controller 900 fixes the upper protrusions 210 in a row unit of the row to be fixed by protruding the upper protrusion 210 in a column unit to which the upper protrusion 210 to be protruded belongs, and by fixing the corresponding row.

In other words, when the upper support block 300 fixes the upper blocks 200 in a row unit, the lower adjustment unit 600 controls the lower blocks 400 not to protrude up to a predetermined height in a column unit.

In addition, when the upper support block 300 fixes the upper blocks 200 in a column unit, the lower adjustment unit 600 controls the lower blocks 400 not to protrude up to a predetermined height in a row unit.

In the display unit 100, a plurality of through holes 101 is formed in a predetermined array.

In the display unit 100, a plurality of through holes 101 is formed in a predetermined array to display information such as Braille words, figures, and images as a plurality of protrusions protrudes through the plurality of through holes 101. For example, the plurality of through holes 101 may be formed in various arrays such as 100 rows*50 columns.

The upper block 200 is provided below each through hole 101, vertically moves, and an upper protrusion 210 thereof protrudes through the through hole 101 when the upper block 200 upwardly moves.

The upper protrusion 210 may be protruded upward or may be recessed into the through hole 101 as the upper block 200 vertically moves.

The upper support block 300 fixes the upper block 200 in a row unit by horizontally moving.

The upper support block 300 may fix the upper block 200 while the upper protrusion 210 of the upper block 200 is protruded to above the through hole 101, and fixes the upper block 200 while the upper protrusion 210 of the upper block 200 is recessed into the through hole 101.

The lower block 400 is provided below each upper block 200, vertically moves, and upwardly pushes the upper block 200 when the lower block 400 upwardly moves.

The lower block 400 may upwardly push the upper block 200 which is not fixed by the upper support block 300.

The elastic unit 500 is provided below each lower block 400, and provides force for upwardly pushing the lower block 400.

The lower adjustment unit 600 controls the lower block 400 not to protrude up to a predetermined height in a column unit by horizontally moving.

In other words, when the lower adjustment unit 600 upwardly pushes the lower block 400 up to a maximum height, the lower block 400 upwardly moves by the force of the elastic unit 500. Accordingly, the lower block 400 may upwardly push the upper block 200, and the upper block 200 that is not fixed by the upper support block 300 may be upwardly pushed. Then, the upper block 200 may be fixed by the upper support block 300.

The row driving unit 800 horizontally moves the upper support block 300.

The row driving unit 800 moves the upper support block 300 by performing a control command that fixes the row or releases a fixed state of the row in a row unit, thus the upper blocks 200 become fixed or become a state in which the upper blocks 200 are movable.

The column driving unit 850 horizontally moves the lower adjustment unit 600.

The column driving unit 850 moves the lower adjustment unit 600 by performing a control command that protrudes up or falls down a column in a column unit such that the lower blocks 400 do not protrude up to a predetermined height.

The controller 900 controls the row driving unit 800 and the column driving unit 850.

The controller 900 controls the row driving unit 800 and the column driving unit 850 by transmitting a control command that fixes a row or releases a fixed state of the row in a row unit to the row driving unit 800, and transmitting a control command that protrudes up or falls down a column in a column unit to the column driving unit 850.

In FIGS. 1 and 2, a movement direction of the upper support block 300 is perpendicular to a movement direction of the lower adjustment unit 600, but the present invention is not limited thereto. When the upper support block 300 fixes the upper block 200 in a row or column unit, and the lower adjustment unit 600 controls the lower block 400 not to protrude up to a predetermined height in a column or row unit, movement directions of the upper support block 300 and the lower adjustment unit 600 may be variably implemented.

The upper support block 300 is provided in left and right sides. A left side upper support block 300 fixes the upper blocks 200 of a left side area, and a right side upper support block 300 fixes the upper blocks 200 of a right side area. The row driving unit 800 is provided in left and right sides (refer to FIG. 25). The left side row driving unit 800 horizontally moves the left side upper support block 300, and the right side row driving unit 800 horizontally moves the right side upper support block 300.

This is because, a load applied to single upper support block 300 and row driving unit 800 becomes large when a length of a row becomes long, thus overload may be applied thereto. In order to solve the above problem, the upper support block 300 and the row driving unit 800 may be provided in both sides so that the load may be distributed.

Herein, the left side upper support block 300 and the left side row driving unit 800 may be controlled separately from the right side upper support block 300 and the right side row driving unit 800.

For example, when controlling the upper blocks 200 of the left area, the left side upper support block 300 and the left side row driving unit 800 are only controlled.

The lower adjustment unit 600 is provided in upper and lower sides. An upper side lower adjustment unit 600 controls the lower blocks 400 of an upper area not to protrude up to a predetermined height, and a lower side lower adjustment unit 600 controls the lower blocks 400 of a lower area not to protrude up to a predetermined height. The column driving unit 850 is provided in upper and lower sides (refer to FIG. 25). An upper side column driving unit 850 horizontally moves the upper side lower adjustment unit 600, and a lower side column driving unit 850 horizontally moves the lower side lower adjustment unit 600.

This is because, a load applied to single lower adjustment unit 600 and column driving unit 850 becomes large when a length of a column becomes long, thus overload may be applied thereto. In order to solve the above problem, the lower adjustment unit 600 and the column driving unit 850 may be provided in both sides so that the load may be distributed.

The upper side lower adjustment unit 600 and the upper side column driving unit 850 may be controlled separately from the lower side lower adjustment unit 600 and the lower side column driving unit 850.

For example, when controlling the upper blocks 200 of the upper area, the upper side lower adjustment unit 600 and the upper side column driving unit 850 are only controlled.

As shown in FIGS. 3 to 5, in the display system for visually impaired persons according to an embodiment of the present invention, the upper block 200 may include an upper protrusion 210, a movement shaft portion 220, an upper-end upward movement stopper 230, an upper pillar portion 240, and an engagement portion 250.

The movement shaft portion 220 is formed to extend from a lower part of the upper protrusion 210, to have a form corresponding to the through hole 101, and to have a column shape having a horizontal cross-sectional area smaller than a horizontal cross-sectional area of the through hole 101.

The movement shaft portion 220 reciprocates the interior of the through hole 101. Herein, the upper block 200 upwardly moves by force upwardly pushed by the lower block 400, and the upper block 200 moves downwardly by gravity. Accordingly, in order to prevent a situation where the movement shaft portion 220 is sandwiched in the through hole 101 so that the movement shaft portion 220 cannot move downwardly by gravity, it is preferable to form the movement shaft portion 220 to have a form corresponding to the through hole 101, and to have the horizontal cross-sectional area smaller than the horizontal cross-sectional area of the through hole 101.

The upper-end upward movement stopper 230 is formed to extend from a lower part of the movement shaft portion 220, and to have a column shape having a horizontal cross-sectional area greater than the horizontal cross-sectional area of the through hole 101.

The upper-end upward movement stopper 230 is provided below the display unit 100, and functions to prevent the upper block 200 from protruding the through hole 101 more than necessary.

The upper pillar portion 240 is formed to extend from a lower part of the upper-end upward movement stopper 230, and to have a column shape having a horizontal cross-sectional area smaller than the horizontal cross-sectional area of the upper-end upward movement stopper 230.

The upper pillar portion 240 is a configuration for vertically moving the upper block 200, and may vertically move while the upper support block 300 that will be described later is coupled therewith.

The engagement portion 250 is formed on a side surface of the upper pillar portion 240 by being protruded (refer to FIGS. 3 to 4) or depressed (refer to FIGS. 3 to 4) in a horizontal direction.

The engagement portion 250 is a configuration for fixing the upper block 200 by using the upper support block 300 that will be described later.

As shown in FIG. 6, in the display system for visually impaired persons according to an embodiment of the present invention, the upper block 200 may further include an upper-end downward movement stopper 260 formed to extend from a lower part of the upper pillar portion 240, and to have a column shape having a horizontal cross-sectional area greater than the horizontal cross-sectional area of the upper pillar portion 240.

The upper-end downward movement stopper 260 bumps into the upper support block 300 that will be described later so that the upper block 200 may not protrude through the through hole 101 more than necessary. The above function is identical to the function of the upper-end upward movement stopper 230, the upper-end downward movement stopper 260 prevents the upper-end upward movement stopper 230 from being damaged, and simultaneously prevents the upper block 200 from protruding through the through hole 101 more than necessary even though the upper-end upward movement stopper 230 is damaged.

It is preferable that cross-sectional forms of the upper-end upward movement stopper 230 and the upper-end downward movement stopper 260 are identical. This is for facilitating vertical reciprocating movements of the upper block 200 in a housing that will be described later since the interior of the housing is formed in a basic column shape.

As shown in FIGS. 2, 4, and 5, in the display system for visually impaired persons according to an embodiment of the present invention, the upper support block 300 is coupled with the upper block 200 so that the upper support block 300 horizontally moves based on the upper pillar portion 240, and includes a movement slot 301 so that the upper pillar portion 240 vertically moves therein.

The movement slot 301 is formed whereby the engagement portion 250 passes as the upper support block 300 moves, or is formed whereby the engagement portion 250 cannot pass as the upper support block 300 moves.

For example, in FIG. 2, when the upper support block 300 moves to a direction where the engagement portion 250 is protruded, the upper block 200 may vertically move. Alternatively, when the upper support block 300 moves to a direction opposite where the engagement portion 250 is protruded, the upper block 200 is fixed.

In FIG. 4, the engagement portion 250 may move toward the movement slot 301 when positions of the engagement portion 250 and the movement slot 301 are in association therewith.

In FIG. 5, when the upper support block 300 moves to a direction opposite to where the engagement portion 250 is recessed, the upper block 200 may vertically move. Alternatively, when the upper support block 300 moves to a direction where the engagement portion 250 is recessed, the upper block 200 is fixed.

Describing operations of the upper block 200 and the upper support block 300 of the display system for visually impaired persons according to an embodiment of the present invention with reference to FIGS. 7 to 9,

FIG. 7 shows a cross-sectional view where the upper block 200 is fixed by the upper support block 300.

When the upper block 200 of FIG. 7 is pushed to the right side as FIG. 8 so that it becomes a state shown in FIG. 9, the upper block 200 moves downwardly by gravity as shown in FIG. 9.

In other words, when the upper block 200 is not fixed by the upper support block 300, the upper block 200 upwardly moves since the lower block 400 upwardly pushes the upper block 200. Otherwise, the upper block 20 moves downwardly by gravity.

As shown in FIGS. 10 and 11, the lower block 400 of the display system for visually impaired persons according to an embodiment of the present invention may include a lower-end upward movement stopper 410, a lower pillar portion 420, a lower-end downward movement stopper 430, and a first inclined portion 440.

The lower-end upward movement stopper 410 is formed to have a column shape.

The lower-end upward movement stopper 410 functions to prevent the lower block 400 from downwardly moving more than necessary by being bumped into the lower adjustment unit 600 that will be described later.

The lower pillar portion 420 is formed to extend from a lower part of the lower-end upward movement stopper 410, and to have a horizontal cross-sectional area smaller than a horizontal cross-sectional area of the lower-end upward movement stopper 410.

The lower pillar portion 420 is a configuration for vertically moving the lower block 400, and may vertically move while the lower adjustment unit 600 that will be described later is coupled therewith.

The lower-end downward movement stopper 430 is formed to extend from a lower part of the lower pillar portion 420, and to have a horizontal cross-sectional area greater than the horizontal cross-sectional area of the lower pillar portion 420.

The lower-end downward movement stopper 430 functions to prevent the lower block 400 from upwardly moving more than necessary by being bumped into the lower adjustment unit 600 that will be described later.

The first inclined portion 440 is formed to be upwardly inclined from the lower-end downward movement stopper 430.

The first inclined portion 440 is a configuration for downwardly pushing the lower block 400, and is formed with an included surface so that the lower block 400 vertically moves as the lower adjustment unit 600 that will be described later horizontally moves.

It is preferable that cross-sectional forms of the lower-end upward movement stopper 410 and the lower-end downward movement stopper 430 are identical. This is for facilitating vertical reciprocating movement of the upper block 200 in a housing that will be described later since the interior of the housing is formed in a basic column shape.

As shown in FIG. 12, in the display system for visually impaired persons according to an embodiment of the present invention, the lower adjustment unit 600 is coupled with the lower block 400 so that the lower adjustment unit 600 horizontally moves based on lower pillar portion 420, and includes a second inclined portion 610 formed to have a form corresponding to the first inclined portion 440. The first inclined portion 440 and the second inclined portion 610 face and are in contact with each other so that the lower block 400 moves downwardly as the lower adjustment unit 600 horizontally moves.

The lower adjustment unit 600 includes a second inclined portion 610 formed to have an inclined surfaces corresponding to the first inclined portion 440. The second inclined portion 610 is a configuration for vertically moving the lower block 400 as the lower adjustment unit 600 horizontally moves. As shown in FIG. 4, the second inclined portion 610 may be formed to be protruded, or may be formed to be depressed.

In addition, force for upwardly moving the lower block 400 by the elastic unit 500 is provided to the lower block 400, thus the lower block 400 upwardly moves until to be bumped with the lower adjustment unit 600. Herein, a height of the lower block 400 may be adjusted by horizontally moving the lower adjustment unit 600

As shown in FIG. 11, in the display system for visually impaired persons according to an embodiment of the present invention, an elastic coupling portion 431 is formed to have a groove or protrusion form in a lower part of the lower-end downward movement stopper 430 so that the elastic unit 500 is coupled therein.

In FIG. 11, an elastic coupling portion 431 formed with a groove form is shown, but the present invention is not limited thereto. The elastic coupling portion 431 may be formed to have a protrusion so that the elastic unit 500 is inserted thereinto.

Describing an operation of the display system for visually impaired persons according to an embodiment of the present invention with reference to FIGS. 13 to 15,

FIG. 13 is a cross sectional view where the lower block 400 is upwardly pushed by the elastic unit 500.

When the lower adjustment unit 600 of FIG. 13 is pushed to the right side as FIG. 14 so that becomes a state shown in FIG. 15, the upper block 200 moves downwardly by gravity as shown in FIG. 15.

In other words, when the upper block 200 is not fixed by the upper support block 300 and the lower adjustment unit 600 downwardly pushes the lower block 400, the upper block 200 moves downwardly by gravity.

Based on this, describing the entire operation of the display system for visually impaired persons with an example in which through holes 101 are formed in an array of 10 (rows)*10 (columns), the lower adjustment unit 600 controls the lower block 400 in a column unit, and the upper support block 300 controls the upper block 200 in a row unit,

Columns to be protruded in a first row are protruded by operating the lower adjustment unit 600, and the first row is fixed by operating the upper support block 300. Then, columns to be protruded in a second row are protruded by operating the lower adjustment unit 600, and the second row is fixed by operating the upper support block 300.

By repeating the above process up to a tenth row, displaying of 10 (rows)*10 (columns) is completed.

Accordingly, in order to express 10 (rows)*10 (columns), ten lower adjustment units 600 and ten upper support blocks 300 are required, thus the 10 (rows)*10 (columns) may be expressed by controlling twenty units.

As shown in FIG. 16, the display system for visually impaired persons according to an embodiment of the present invention may further include a housing 700 storing the upper block 200 and the lower block 400 therein, and storing the upper support block 300 and the lower adjustment unit 600 so that first side portions of the upper support block 300 and the lower adjustment unit 600 outwardly protrude.

The housing 700 may be formed to be integrated with the display unit 100, or may be formed to be dissembled into a plurality of parts when necessary.

The housing 700 is formed with an upper guide slot 710 such that the upper support block 300 horizontally moves, and a horizontal height of the upper support block 300 is maintained, and a lower guide slot 720 such that the lower adjustment unit 600 horizontally moves, and a horizontal height of the lower adjustment unit 600 is maintained.

It is preferable to maintain heights of the upper support block 300 and the lower adjustment unit 600 to be constant. For this, it is preferable to form the upper guide slot 710 for horizontal movements of the upper support block 300 and to form the lower guide slot 720 for horizontal movements of the lower adjustment unit 600 in the housing 700.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A display module for visually impaired persons, the display module comprising:
a display unit (100) in which a plurality of through holes (101) is formed in a predetermined array;
an upper block (200) provided below each through hole (101) and vertically moving whereby an upper protrusion (210) thereof upwardly protrudes above the through hole (101) when the upper block (200) upwardly moves;
an upper support block (300) fixing the upper block (200);
a lower block (400) provided below each upper block (200), vertically moving, and upwardly pushing the upper block (200) when the lower block (400) upwardly moves;
an elastic unit (500) provided below each lower block (400) and providing force to upwardly push the lower block (400); and
a lower adjustment unit (600) adjusting the lower block (400) not to protrude up to a predetermined height,
wherein
the upper support block (300) fixes the upper blocks in a row or column unit,
and the lower adjustment unit (600) controls the lower blocks (400) not to protrude up to the predetermined height in a column or row unit.

2. The display module of claim 1, wherein the upper block (200) includes:
a movement shaft portion (220) formed to extend from a lower part of the upper protrusion (210), to have a form corresponding to the through hole (101) and to have a column shape having a horizontal cross-sectional area smaller than a horizontal cross-sectional area of the through hole (101);
an upper-end upward movement stopper (230) formed to extend from a lower part of the movement shaft portion (220), and to have a column shape having a horizontal cross-sectional area greater than the horizontal cross-sectional area of the through hole (101);
an upper pillar portion (240) formed to extend from a lower part of the upper-end upward movement stopper (230), and to have a column shape having a horizontal cross-sectional area smaller than the horizontal cross-sectional area of the upper-end upward movement stopper (230); and
an engagement portion (250) formed on a side surface of the upper pillar portion (240) by being protruded or depressed in a horizontal direction.

3. The display module of claim 2, wherein the upper block (200) further includes an upper lower part movement limiting portion (260) formed to extend from a lower part of the upper pillar portion (240), and to have a column shape having a horizontal cross-sectional area greater than the horizontal cross-sectional area of the upper pillar portion (240).

4. The display module of claim 2, wherein the upper support block (300) is coupled with the upper pillar portion (240) so that the upper support block (300) moves in a horizontal direction based on the upper pillar portion (240), and includes a movement slot (301) so that the upper pillar portion (240) vertically moves therein.

5. The display module of claim 1, wherein the lower block (400) includes:
a lower-end upward movement stopper (410) formed to have a column shape;
a lower pillar portion (420) formed to extend from a lower part of the lower-end upward movement stopper (410), and to have a column shape having a horizontal cross-sectional area smaller than a horizontal cross-sectional area of the lower-end upward movement stopper (410);
a lower-end downward movement stopper (430) formed to extend from a lower part of the lower pillar portion (420), and to have a column shape having a horizontal cross-sectional area greater than the horizontal cross-sectional area of the lower pillar portion (420); and
a first inclined portion (440) formed to be upwardly included from the lower-end downward movement stopper (430),
wherein
the lower adjustment unit (600) is coupled with the lower block (400) so that the lower adjustment unit (600) moves in a horizontal direction based on the lower pillar portion (420), and includes a second inclined portion (610) formed to have an inclined surface corresponding to the first inclined portion (440), wherein
the first inclined portion (440) and the second inclined portion (610) face and are in contact with each other so that the lower block (400) moves downwardly as the lower adjustment unit (600) moves in the horizontal direction.

6. The display module of claim 5, wherein the lower-end downward movement stopper (430) includes an elastic coupling portion (431) having a groove or protrusion form so that the elastic unit (500) is coupled therein.

7. The display module of claim 1, further comprising:
a housing (700) storing the upper block (200) and the lower block (400) therein, and storing the upper support block (300) and the lower adjustment unit (600) so that parts of respective first sides of the upper support block (300) and the lower adjustment unit (600) outwardly protrude;
wherein the housing (700) includes:
an upper guide slot (710) whereby the upper support block (300) horizontally moves, and a horizontal height of the upper support block (300) is maintained; and
a lower guide slot (720) whereby the lower adjustment unit (600) horizontally moves, and a horizontal height of the lower adjustment unit (600) is maintained.

8. A controlling method for a display system for visually impaired persons, wherein the system includes a display unit (100) in which a plurality of through holes (101) is formed in a predetermined array, a column driving unit (850) protruding upper protrusions (210) in a column unit above the display unit (100) according to a control command of a controller (900), and a row driving unit (800) fixing the upper protrusions (210) in a row unit according to a control command of the controller (900), the method comprising:
step (S10) of releasing, by the row driving unit (800), fixed states of the upper protrusions (210) of a row to be displayed;
step (S20) of protruding, by the column driving unit (850), the upper protrusion (210) of a column to be displayed of the row in which the fixed states of the upper protrusions (210) are released in step (S10);
step (S30) of fixing, by the row driving unit (800), the upper protrusions (210) of the row in which the fixed states of the upper protrusions (210) are released in step (S10); and
step (S40) of returning, by the column driving unit (850), to an initial state thereof which has been driven in step (S20),
wherein steps (S10) to (S40) are sequentially repeatedly performed in accordance with an order of predetermined rows.

9. The method of claim 8, wherein an initialization of releasing the fixed state of the row fixed in step (S30) is available.

10. A display system for visually impaired persons, the system comprising:
a display unit (100) in which a plurality of through holes (101) is formed in a predetermined array;
an upper block (200) provided below each through holes (101) and vertically moving whereby an upper protrusion (210) thereof upwardly protrudes above the through hole (101) when the upper block (200) upwardly moves;
an upper support block (300) fixing the upper block (200) in a row unit by horizontally moving;
a lower block (400) provided below each upper block (200) and vertically moving, and upwardly pushing the upper block (200) when the lower block (400) upwardly moves;
an elastic unit (500) provided below each lower block (400) and providing force to upwardly push the lower block (400); and
a lower adjustment unit (600) controlling the lower block (400) in a column unit not to protrude up to a predetermined height;
a row driving unit (800) horizontally moving the upper support block (300);
a column driving unit (850) horizontally moving the lower adjustment unit (600); and
a controller (900) controlling the row driving unit (800) and the column driving unit (850), wherein
the controller (900) fixes the upper protrusions 210 in a row unit by protruding the upper protrusion 210 in a column unit to which the upper protrusion 210 to be protruded belongs of the row to be fixed, and by fixing the corresponding row.

11. The display system of claim 10, wherein the upper support block (300) is provided in left and right sides, a left side upper support block (300) fixes the upper blocks (200) of a left area, and a right left side upper support block (300) fixes the upper blocks (200) of a right area, and
the row driving unit (800) is provided in left and right sides, a left side row driving unit (800) horizontally moves the left side upper support block (300), and a right side row driving unit (800) horizontally moves the right left side upper support block (300).

12. The display system of claim 11, wherein the left side upper support block (300) and the left side row driving unit (800) are controlled separately from the right side upper support block (300) and the right side row driving unit (800).

13. The display system of claim 10, wherein the lower adjustment unit (600) is provided in upper and lower sides, an upper side lower adjustment unit (600) adjusts the lower blocks (400) of an upper area not to protrude up to a predetermined height, and a lower side lower adjustment unit (600) adjusts the lower blocks (400) of a lower area not to protrude up to a predetermined height, and
the column driving unit (850) is provided in upper and lower sides, an upper side column driving unit (850) horizontally moves the upper side lower adjustment unit (600), and a lower side column driving unit (850) horizontally moves the lower side lower adjustment unit (600).

14. The display system of claim 13, wherein the upper side lower adjustment unit (600) and the upper side column driving unit (850) are controlled separately from the lower side lower adjustment unit (600) and the lower side column driving unit (850).

15. The display system of claim 10, wherein the upper block (200) includes:
a movement shaft portion (220) formed to extend from a lower part of the upper protrusion (210), to have a form corresponding to the through hole (101), and to have a column shape having a horizontal cross-sectional area smaller than a horizontal cross-sectional area of the through hole (101);
an upper-end upward movement stopper (230) formed to extend from a lower part of the movement shaft portion (220), and to have a column shape having a horizontal cross-sectional area greater than the horizontal cross-sectional area of the through hole (101);
an upper pillar portion (240) formed to extend from a lower part of the upper-end upward movement stopper (230), and to have a column shape having a horizontal cross-sectional area smaller than the horizontal cross-sectional area of the upper-end upward movement stopper (230); and
an engagement portion (250) formed on a side surface of the upper pillar portion (240) by being protruded or depressed in a horizontal direction.

16. The display system of claim 15, wherein the upper block (200) further includes an upper lower part movement limiting portion (260) formed to extend from a lower part of the upper pillar portion (240), and to have a column shape having a horizontal cross-sectional area greater than the horizontal cross-sectional area of the upper pillar portion (240).

17. The display system of claim 15, wherein the upper support block (300) is coupled with the upper pillar portion (240) so that the upper support block (300) moves in a horizontal direction based on the upper pillar portion (240), and includes a movement slot (301) so that the upper pillar portion (240) vertically moves therein.

18. The display system of claim 10, wherein the lower block (400) includes:
a lower-end upward movement stopper (410) formed to have a column shape;
a lower pillar portion (420) formed to extend from a lower part of the lower-end upward movement stopper (410), and to have a column shape having a horizontal cross-sectional area smaller than a horizontal cross-sectional area of the lower-end upward movement stopper (410);
a lower-end downward movement stopper (430) formed to extend from a lower part of the lower pillar portion (420), and to have a column shape having a horizontal cross-sectional area greater than the horizontal cross-sectional area of the lower pillar portion (420); and
a first inclined portion (440) formed to be upwardly included from the lower-end downward movement stopper (430),
wherein the lower adjustment unit (600) is coupled with the lower block (400) so that the lower adjustment unit (600) moves in a horizontal direction based on the lower pillar portion (420), and includes a second inclined portion (610) formed to have an inclined surface corresponding to the first inclined portion (440), wherein
the first inclined portion (440) and the second inclined portion (610) face and are in contact with each other so that the lower block (400) moves downwardly as the lower adjustment unit (600) moves in the horizontal direction.

19. The display system of claim 18, wherein the lower-end downward movement stopper (430) includes an elastic portion (431) having a groove or protrusion form so that the elastic unit (500) is coupled therein.

20. The display system of claim 10, further comprising:
a housing (700) storing the upper block (200) and the lower block (400) therein, and storing the upper support block (300) and the lower adjustment unit (600) so that parts of respective first sides of the upper support block (300) and the lower adjustment unit (600) outwardly protrude;
wherein the housing (700) includes:
an upper guide slot (710) whereby the upper support block (300) horizontally moves, and a horizontal height of the upper support block (300) is maintained; and
a lower guide slot (720) whereby the lower adjustment unit (600) horizontally moves, and a horizontal height of the lower adjustment unit (600) is maintained.
